(19) United States
(12) Patent Application Publication
(10) Pub. No.: US 2019/0102725 A1
(43) Pub. Date: Apr. 4, 2019

(54) DETERMINATION OF EMPLOYMENT START DATE

(71) Applicant: Microsoft Technology Licensing, LLC, Redmond, WA (US)

(72) Inventors: Xin Xia, Pacifica, CA (US); Michael Jennings, San Francisco, CA (US); Ted Tomlinson, Oakland, CA (US)

(21) Appl. No.: 15/793,849

(22) Filed: Oct. 25, 2017

Related U.S. Application Data
(60) Provisional application No. 62/566,364, filed on Sep. 30, 2017.

(51) Int. Cl. G06Q 10/06; G06F 17/30; G06Q 10/10; G06Q 50/00

(52) U.S. Cl. CPC G06Q 10/063114; G06F 17/30699; G06Q 50/01; G06Q 10/063116; G06Q 10/1093; G06Q 10/1053

(57) ABSTRACT

Methods, systems, and computer programs are presented for determining employment start dates for members of a social network that have not indicated their employment start date in their profiles to generate employment market reports. One method includes an operation for receiving a request to infer a member start date for a member with an unknown member start date at a company. A distribution over time of known member start dates is determined for members of the social network with a known employment start date at the company, and a time interval is identified defining the boundaries for the member start date. A cohort group is selected from several cohort groups, that include members with known member start dates having a same cohort feature value as the member. A start-date probability distribution is determined based on the distribution of the known member start dates, the cohort group, and the time interval.

### CLAIM OF PRIORITY

This application claims priority from U.S. Provisional Patent Application No. 62/566,364, filed Sep. 30, 2017, and entitled “Employer Ranking for Inter-Company Employee Flow.” This provisional application is herein incorporated by reference in its entirety.

### TECHNICAL FIELD

The subject matter disclosed herein generally relates to methods, systems, and programs for determining missing user data from a profile of a user in a social network.

### BACKGROUND

Employment market data is very important for fast growing companies because these companies want to understand employment-related data, such as what the population is for a given skill set, where potential employees are located, what the typical compensation is, whether people for a certain skill are changing jobs often, etc. Further, a good understanding of the labor market may assist a company deciding where to establish a new site because the company may choose a site with a readily-available workforce.

However, employment data is usually kept secret by most companies, which merely provide, sometimes, the number of employees of the company. Therefore, getting a thorough understanding of the labor market based on available skills and geography is a difficult task.

A key piece of employment information is the start date of employment at a company to identify hiring statistics, inter-company migrations, and other employment-related statistical values. Sometimes, users enter employment data when they are updating their profile in a social network. However, many times users enter the company and the title but fail to indicate the start date.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user's profile, according to some example embodiments.

FIG. 3 illustrates data structures for storing job and member information, according to some example embodiments.

FIG. 4 is a chart showing a distribution of company hires for employees with known start dates, according to some example embodiments.

FIG. 5 illustrates a method for generating a start-date probability distribution for a user, according to some example embodiments.

FIG. 6 illustrates an example embodiment for generating the start-date probability distribution.

FIG. 7 illustrates the merging of the known start dates with the inferred start-date probabilities to create an overall distribution that may be used for generating a talent report, according to some example embodiments.

FIG. 8 illustrates the training and use of a machine-learning program, according to some example embodiments.

FIG. 9 is flowchart of a method for determining employment start dates for members of a social network that have not indicated their employment start date in their profiles to generate employment market reports, according to some example embodiments.

FIG. 10A is a chart showing the evolution of the company score over time for several companies, according to some example embodiments.

FIG. 10B is a report representing employee inflow over time for a plurality of companies, before smoothing, according to some example embodiments.

FIG. 10C is a report representing employee inflow over time for a plurality of companies after smoothing, according to some example embodiments.

FIG. 11 is a talent pool report, according to some example embodiments.

FIG. 12 is a talent geographic map, according to some example embodiments.

FIG. 13 is a talent-distribution report by company, according to some example embodiments.

FIG. 14 is a talent report by educational institution, according to some example embodiments.

FIG. 15 is a talent report by user skill, according to some example embodiments.

FIG. 16 is a workforce-distribution report for a company, according to some example embodiments.

FIG. 17 is a timeline for hires and departures of a given company, according to some example embodiments.

FIG. 18 is a company report by function, according to some example embodiments.

FIG. 19 is a report for talent flow between companies, according to some example embodiments.

FIG. 20 is a block diagram illustrating a representative software architecture, which may be used in conjunction with various hardware architectures herein described.

FIG. 21 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to determining employment start dates for members of a social network that have not indicated their employment start date in their profiles in order to generate employment market reports. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Social networks do not always require members to specify a start date of a particular job when members enter experience information in their profiles. In some cases, there could be 30% of the total number of members that have a missing start date in their employment information. Further, some members may enter their experience profile on the social network at the time that they join, therefore, their joining date may not be utilized as a reliable signal for determining employment start dates.

Start dates are important when determining employment data for the market. It is possible to create reports for companies that identify their number of hires and departures over time, as well as how many employees are transition from one company to another, to name a few of the possible employment reports. Missing start dates may hinder the accuracy of the employment reports.

Solutions presented herein analyze multiple signals associated with the company and members with unknown employment start dates in order to generate reliable data for generating reports. An analysis is made of the members of the social network that have a known start date, and the features of the members with known start dates are compared to the features of the members with unspecified start dates to determine probability distributions for the unknown start dates. These probability distributions are then used to generate accurate employment reports, also referred to herein as talent reports.

In one embodiment, a method is provided. The method includes an operation for receiving a request to infer a member start date for a member of a social network with an unknown member start date for starting employment at a company. Additionally, the method includes an operation for determining a distribution over time of known member start dates for members of the social network with a known employment start date at the company. A time interval is identified, the time interval defining the boundaries for the member start date. Additionally, the method includes an operation for selecting a cohort group from one or more cohort groups, each cohort group including members with known member start dates that have a same cohort feature value as the member, each cohort group having a different cohort feature value. Further, the method includes an operation for determining a member start-date probability distribution over time based on the distribution over time of known member start dates, the cohort group, and the time interval.

In another embodiment, a system includes a memory comprising instructions and one or more computer processors. The instructions, when executed by the one or more computer processors, cause the one or more computer processors to perform operations comprising: receiving a request to infer a member start date for a member of a social network with an unknown member start date, the member start date being for starting employment at a company; determining a distribution over time of known member start dates for members of the social network with a known employment start date at the company; identifying a time interval that identifies boundaries for the member start date; selecting a cohort group from one or more cohort groups, each cohort group including members with known member start dates that have a same cohort feature value as the member, each cohort group having a different cohort feature value; and determining a member start-date probability distribution over time based on the distribution over time of known member start dates, the cohort group, and the time interval.

In yet another embodiment, a non-transitory machine-readable storage medium including instructions that, when executed by a machine, cause the machine to perform operations comprising: receiving a request to infer a member start date for a member of a social network with an unknown member start date, the member start date being for starting employment at a company: determining a distribution over time of known member start dates for members of the social network with a known employment start date at the company; identifying a time interval that identifies boundaries for the member start date; selecting a cohort group from one or more cohort groups, each cohort group including members with known member start dates that have a same cohort feature value as the member, each cohort group having a different cohort feature value: and determining a member start-date probability distribution over time based on the distribution over time of known member start dates, the cohort group, and the time interval.

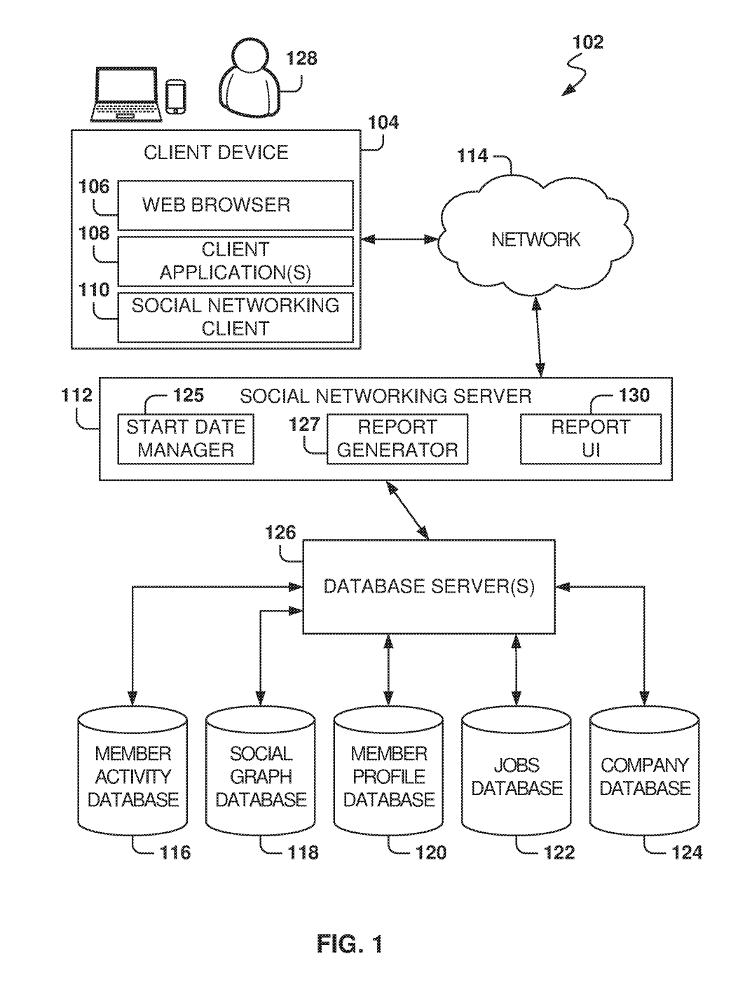

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member; however, some companies may not be members of the social network even though some of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a Representational State Transfer (REST)-Oriented Architecture (ROA), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

The social networking server 112 includes, among other modules, a start date manager 125, a report generator 127, and a talent user interface 130. The modules may be implemented in hardware, software (e.g., programs), or a combination thereof. The start date manager 125 infers the start dates for members having unknown employment start dates, as described in more detail below. The report generator 127 generates the reports associated with the employment data, and the report user interface 130 provides an interface for accessing the reports and options for the report generation.

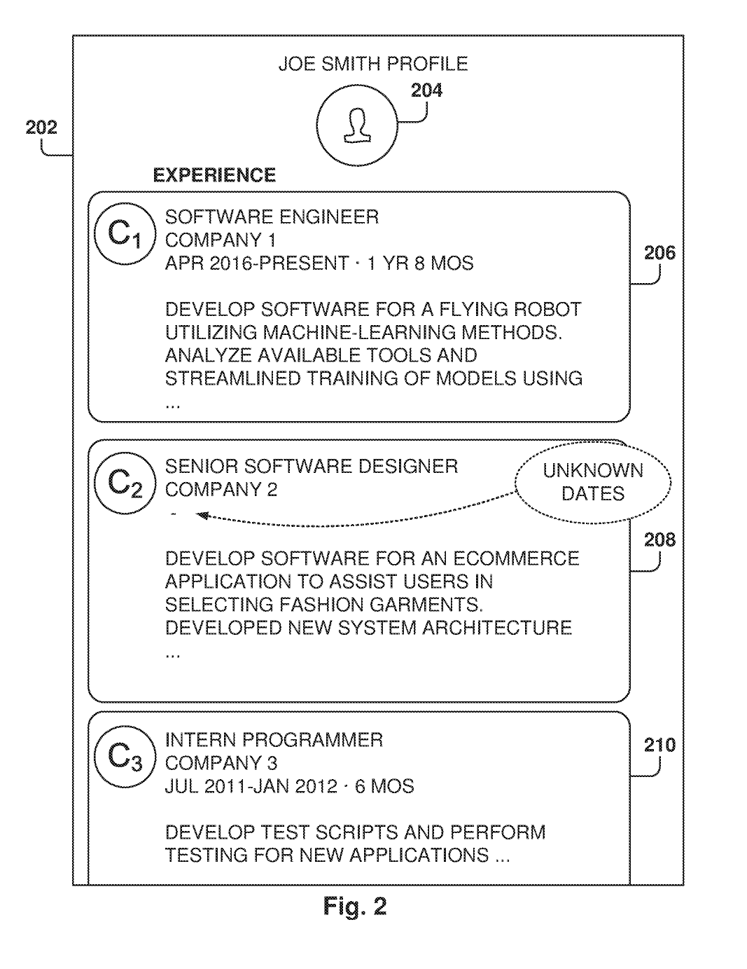

FIG. 2 is a screenshot 202 of a user's profile, according to some example embodiments. In the example embodiment of FIG. 2, the user's profile includes several jobs held by the user 204, in a format similar to the one used for a resume.

In one example embodiment, each job (206, 208, 210) includes a company logo for the employer (e.g., C₁), a title (e.g., software engineer), the name of the employer (e.g., Company 1), dates of employment, and a description of the job tasks or job responsibilities of the user 204. However, for job 208, employment dates are unknown so they are not shown.

When users change jobs, the users tend to update their employment history, although updating may not happen right away. By analyzing the job changes, including end date and start dates, it is possible to identify transitions between companies.

In the exemplary embodiment of FIG. 2, the user has entered three jobs but not provided dates for job 208. The order of entry may be considered as the order of jobs (or other signals may be used, such as title seniority), which means that job 208 followed job 210 and job 206 followed job 208. Job 210 as an intern programmer ended in January 2012, and it may be assumed that the job 208 started after January 2012 and before April 2016, which is the job start date for job 206. As discussed in more detail below, embodiments estimate the start date for job 208 in order to calculate employment data.

The social network analyzes the transitions for the users within the social network and aggregates this transitional data to generate reports based on employee migrations between companies, job titles, job skills, time intervals, etc.

In some example embodiments, the information on the user profiles may be categorized. For example, the company may include a company ID, a title may be assigned a title ID (where the title is standardized to cover a plurality of similar job titles), and a position may be assigned a position ID. In some example embodiments, each job (member_position) of the user may be described utilizing a record with one or more of the following fields: {member_id: int, position_id: int, company_id: int, is_current: boolean (indicating if this is believed to be the user's current job), industry_id: int, position_start_time: long, position_end_time: long}. Other embodiments may include additional fields or fewer fields.

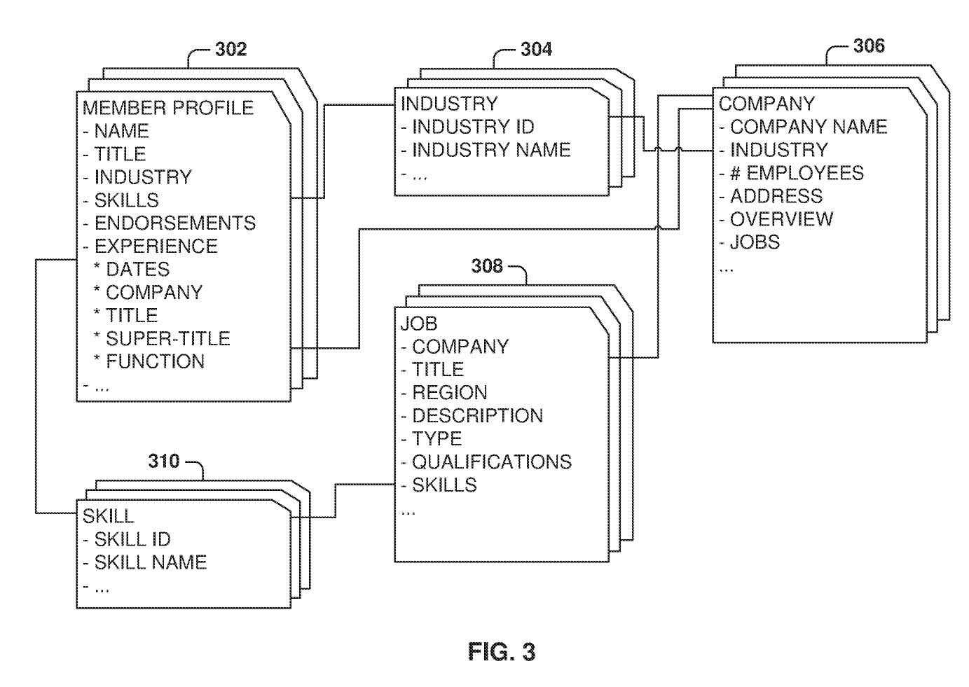

FIG. 3 illustrates data structures for storing job and member information, according to some example embodiments. Each user in the social network has a member profile 302, which includes information about the user. The member profile 302 is configurable by the user and includes information about the user and about user activity in the social network (e.g., likes, posts read).

In one example embodiment, the member profile 302 may include information in several categories, such as experience, education, skills and endorsements, accomplishments, contact information, following, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the account is associated with the number of endorsements received for each skill from other members.

The member profile 302 includes member information, such as name, title (e.g., job title), industry (e.g., legal services), geographic region, jobs, skills and endorsements, and so forth. In some example embodiments, the member profile 302 also includes job-related data, such as employment history, jobs previously applied to, or jobs already suggested to the member (and how many times the job has been suggested to the member). The experience information includes information related to the professional experience of the user, and may include, for each job, dates, company, title, super-title, functional area, industry, etc. Within member profile 302, the skill information is linked to skill data 310, the employer information is linked to company data 306, and the industry information is linked to industry data 304. Other links between tables may be possible.

The skill data 310 and endorsements includes information about professional skills that the user has identified as having been acquired by the user, and endorsements entered by other users of the social network supporting the skills of the user. Accomplishments include accomplishments entered by the user, and contact information includes contact information for the user, such as email and phone number.

The industry data 304 is a table for storing the industries identified in the social network. In one example embodiment, the industry data 304 includes an industry identifier (e.g., a numerical value or a text string), and an industry name, which is a text string associated with the industry (e.g., legal services).

In one example embodiment, the company data 306 includes company information, such as company name, industry associated with the company, number of employees, address, overview description of the company, job postings, and the like. In some example embodiments, the industry is linked to the industry data 304.

The skill data 310 is a table for storing the different skills identified in the social network. In one example embodiment, the skill data 310 includes a skill identifier (ID) (e.g., a numerical value or a text string) and a name for the skill. The skill identifier may be linked to the member profile 302 and job data 308.

In one example embodiment, job data 308 includes data for jobs posted by companies in the social network. The job data 308 includes one or more of a title associated with the job (e.g., software developer), a company that posted the job, a geographic region for the job, a description of the job, a type of job, qualifications required for the job, and one or more skills. The job data 308 may be linked to the company data 306 and the skill data 310.

In some example embodiments, features from the member profiles may be used to infer start dates for a user, based on the features of the user and the features of other users having some common characteristic with the user (e.g., working at the same company, working at the same department, having the same title, etc.).

As used herein, a cohort group, for a given member and a given job of the member in a certain company, is a set of members of the social network that fulfill two conditions: first, each cohort member has the same value for a cohort feature as the given member; and second, the cohort member has a known employment start date at the certain company.

The cohort feature is a characteristic associated with the members, such as any of the values illustrated in FIG. 3. The cohort feature may refer to a single value (e.g., the same company) or include a combination of values, such as software developer in Research & Development at the company. Therefore, if the cohort feature is title within the company, and the given member has a title of data scientist, the cohort group includes the members of the social network that have, or have had, a job at the certain company with the title of data scientist (or equivalent title in some embodiments). Therefore, different cohort groups have different cohort features and different cohort feature values.

In some example embodiments, the following member information is used as features to infer start dates: date when the member joined the social network, country code, industry code, graduation year from school, and school identifier (school may refer also to universities and other types of educational institutions). Other embodiments may utilize additional features or fewer features.

In some example embodiments, the following member information associated with employment data is used as features to infer start dates: company identifier, date the member posted the position at the company, job seniority, job title, and job super-title. The super-title is a value assigned to a group of similar titles. For example, titles such as “software developer,” “application developer,” “programmer,” “software engineer,” “software analyst,” “Java programmer,” etc., may be mapped to a common super-title of “software developer.”

In some example embodiments, the cohort features may be one of more of company identifier, company identifier plus functional area within the company, and company identifier plus super-title within the company.

It is noted that the embodiments illustrated in FIG. 3 are examples and do not describe every possible embodiment. Other embodiments may utilize different data structures, fewer data structures, combine the information from two data structures into one, add additional or fewer links among the data structures, and the like. The embodiments illustrated in FIG. 3 should therefore not be interpreted to be exclusive or limiting, but rather illustrative.

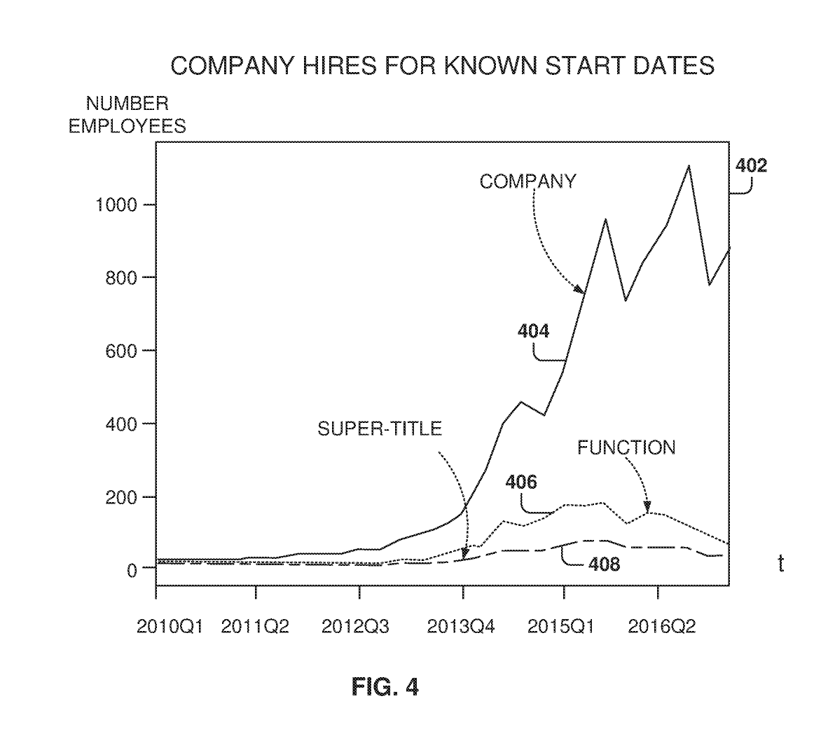

FIG. 4 is a chart 402 showing a distribution of company hires for employees with known start dates, according to some example embodiments. Chart 402 includes numerical information for the number of hires of the company over a period of time. A first line 404 shows the number of hires for the company. A second line 406 shows the number of hires for a particular functional area within the company (e.g., marketing). The third line 408 shows the number of hires for a particular super-title at the company (e.g., sales representatives at the company).

To generate the chart, the member information is accessed for a particular company to determine the members that worked at that company, or at that company and having that function, etc. The known start dates are tallied to determine the illustrated distributions. Chart 402 shows distribution with continuous lines, but other embodiments may obtain distributions of number of employees hired by time period (e.g., month, quarter, six months, one year, etc.).

Based on the information of chart 402, it can be observed that if a member joined the company somewhere between the third quarter of 2012 and the first quarter of 2015, in the absence of any other information, it is more probable that the member joined the company around the first quarter of 2015 because the company was hiring many people at that time, many more than in the third quarter of 2012. In fact, in the absence of any other information, the number of hires between those dates may be used as a probability distribution for the start date, instead of using other blind approaches, such as assigning equal probabilities to any time between the given dates.

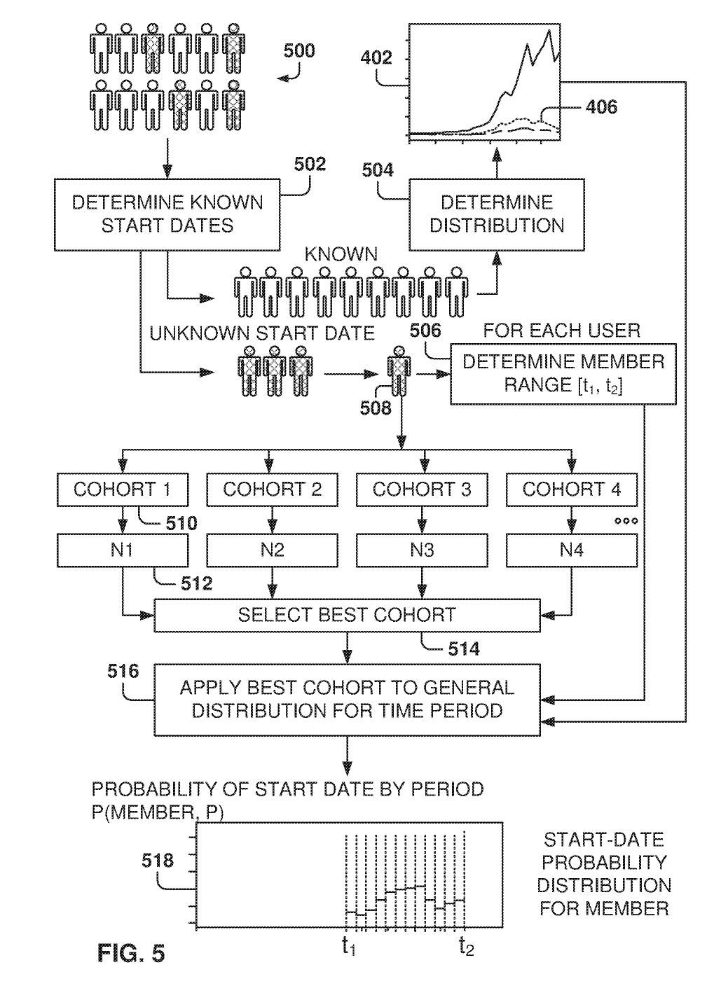

FIG. 5 illustrates a method for generating a start-date probability distribution for a user, according to some example embodiments. A group of members 500 includes the members that worked, or have worked, at a given company. Some of the members have known start dates at the company and other members have unknown start dates at the company. At operation 502, the known start dates are determined for the users with such known start dates. As a result, the members 500 may be divided between members with known as start dates and members with unknown start dates. At operation 504, a distribution 402 of the start dates is determined, as described above with reference to FIG. 4.

Trying to identify the exact date when the member started working at the company may be difficult because there may be a high degree of variance given the known signals for the member. For example, it may be determined that the user joined between 2015 and 2016, but assigning an exact date may be done with low accuracy. However, many of the employment reports are related to an aggregation of user data, such as how many members left the company in a given quarter to join a competitor. In these cases, knowing the specific start dates may not be as important as getting statistical data for large number of employees.

Therefore, it is better for report generation to use probability distributions of the start dates than trying to guess particular start dates. For example, instead of specifying an actual start date, it is more useful to determine that the user may have joined the company with a 30% probability in the first quarter of 2015, a 40% probability in the second quarter of the same year, and a 30% probability in the third quarter, based on the hiring distribution of members of the social network with similar characteristics as the user.

For example, if there are 100 users that joined the company in 2014, the probability distributions of the 100 users may be used to “allocate” users to each of the quarters in 2014 (e.g., 13, 25, 28, and 34 for the four quarters). Since the probability distributions are considered accurate, when aggregated, the overall picture will be accurate.

For each member 508 with an unknown start date, the method performs operations to determine the probability of the start date of the member 508 by period, e.g., assigning probabilities of starting at each of the periods within the report. In some example embodiments, the period used is the quarter of the year, but other periods may be used, such as a year, six months, a month, etc. In some example embodiments, the period utilized for determining the probability distribution will be set based on the report that is being generated. Therefore, if the report utilizes charts and distributions by quarters, the probability of the start date is also calculated by quarter. In other embodiments, the probabilities may be calculated by other intervals, such as calculating probabilities by month and then aggregating the probabilities for the report by quarter.

At operation 506, a member range for the start date of the member is determined, where the member range narrows the possible start dates of the user to a time within the member range. The member range is created based on the information available about the member, such as graduation date, dates for other positions, and date the position was posted in the social network. In one example embodiment, the member range may be between graduation date and the date when the position was entered by the member 508 in the social network. In another example embodiment, the member range may be between two other jobs with defined dates. In another example embodiment, the member range may be between the termination date at one job and the date the position was entered. The goal is to determine the probabilities for the start dates in the different intervals of time for the report included within the identified member range. For example, if the interval for the report is one month, the probability distribution will include a start-date probability for each month within the member range.

In addition, other rules may be used to determine the member range, such as if the position lists only a start year, utilize January of that year; and if the member has posted a graduation year but not the month, utilize January of the graduation year as the lower bound of the member range.

A simple approach would be to distribute the probability equally along the member range. However, the information of the members with known start dates is utilized to better refine the probability distribution. To perform this refinement, cohort groups are utilized.

One or more cohort groups may be utilized for the user 508. In the example of FIG. 5, four cohort groups are illustrated, but other embodiments may utilize a different number of cohort groups (e.g., in the range from 1 to 100).

Each cohort group has a cohort feature associated with it, and the cohort featured determines the members of the cohort group. Based on the cohort group feature, the members of the cohort group are identified and the number of members in the cohort group is counted. For example, cohort group 1 510 has N1 512 members, cohort group 2 has N2 members, cohort group 3 has N3 members, and cohort 4 group has N4 members.

The cohort feature may be very broad, such as just simply company name, or very specific such as software engineer title that graduated in 2015 from Stanford and joined the company.

In general, it is desirable to select a cohort group with a very specific cohort feature value that relates to the user, because the more a specific the cohort featured, the better predictor will be for that particular member 508. On the other hand, cohort groups with a small number of members may not provide a statistically significant information to make good probability inferences. Therefore, a balancing function is performed to obtain cohort groups as a specific as possible as long as they include a minimum number of members.

At operation 514, the best cohort group is selected. In some example embodiments, the best cohort group is selected as the cohort group that correlates more specifically to the user (based on the cohort feature value) and includes a number of members that exceeds a predetermined threshold. For example, a cohort group for the company is less specific than a cohort group for the function within the company, which is less specific than a title within the company. In some example embodiments, the threshold is 100, but other embodiments may utilize thresholds in the range from 25 to 200, or some other value.

This model is very useful for large companies because their hiring numbers over time tend to be much higher than with smaller companies, therefore, there is a better chance to get more statistically significant data to predict at the cohort level.

At operation 516, the best cohort group is applied for generating the probability distribution for the member range of the member 508. This includes creating a distribution for the selected cohort members, similar to the distribution 402 for all the members. For example, if the selected cohort is for function within the company, then distribution 406 may be used, but bound by the member range. This means that the probabilities for the periods outside the member range are set to zero.

Assigning the probability at each period is calculated as the number of cohort members in the period divided by the total number of cohort members that are within the time range. The result is a probability distribution P(member, period) of the probability that member 508 started employment in that period. The sum of the probabilities for each period will then be one.

The embodiment illustrated in FIG. 5 is for utilizing one cohort group, the selected best cohort group. However, in other example embodiments, more than one cohort group may be utilized to generate a probability distribution. A weighted sum may be utilized to add the probabilities that would be generated by each of the cohort groups. This allows to utilize cohort groups with a large number of members, and then refine them with information about cohort groups that are more specific. For example, if a cohort group for title only includes 10 members, the company cohort group may be utilized for 80% of the weight and the smaller cohort group for 20% of the weight.

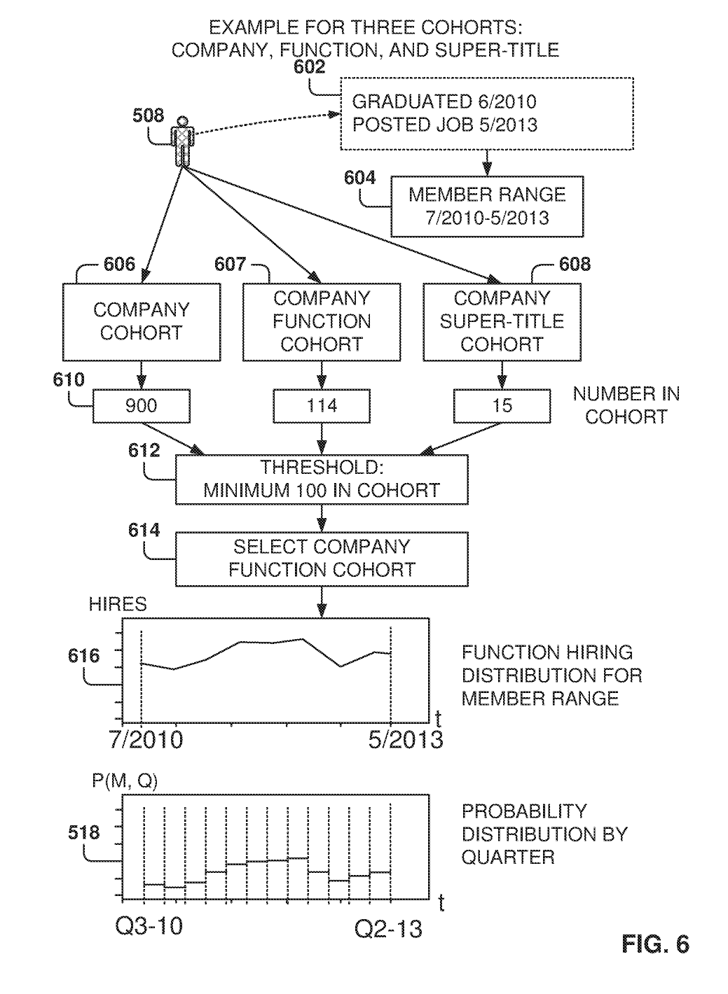

FIG. 6 illustrates an example embodiment for generating the start-date probability distribution. In this example, member 508 graduated in June 2010 and posted job at the company in May 2013. Therefore, the member range 604 is defined as the time period from July 2010 to May 2013.

Three cohort groups have been defined. The first is the company cohort 606 (cohort feature is company identifier), the second is the company function cohort group (cohort feature is function within the company), and the third is the company super-title cohort group (cohort feature is super-title within the company). In one example, the company function cohort group 607 includes employees in the legal department at the company (e.g., the function is legal department), and the company super-title cohort group 608 includes associate attorneys within the company (e.g., the super-title is “associate attorney”).

Thus, the company super-title cohort group 608 is more specific than the company function cohort group 607, which is more specific than the company cohort group 606. The number of members for the cohort groups within the time range are 900, 114, and 15 respectively. The threshold 612 is 100, therefore, the company function cohort group 607 is selected 614 because both the company and company function cohort groups are above the threshold and the company function cohort group 607 is more specific.

In this example embodiment, the period for the report is one quarter. The function hiring distribution 616 for the member range is created, and based on the counts for each quarter, the corresponding probability distribution 518 P(member, quarter) is created.

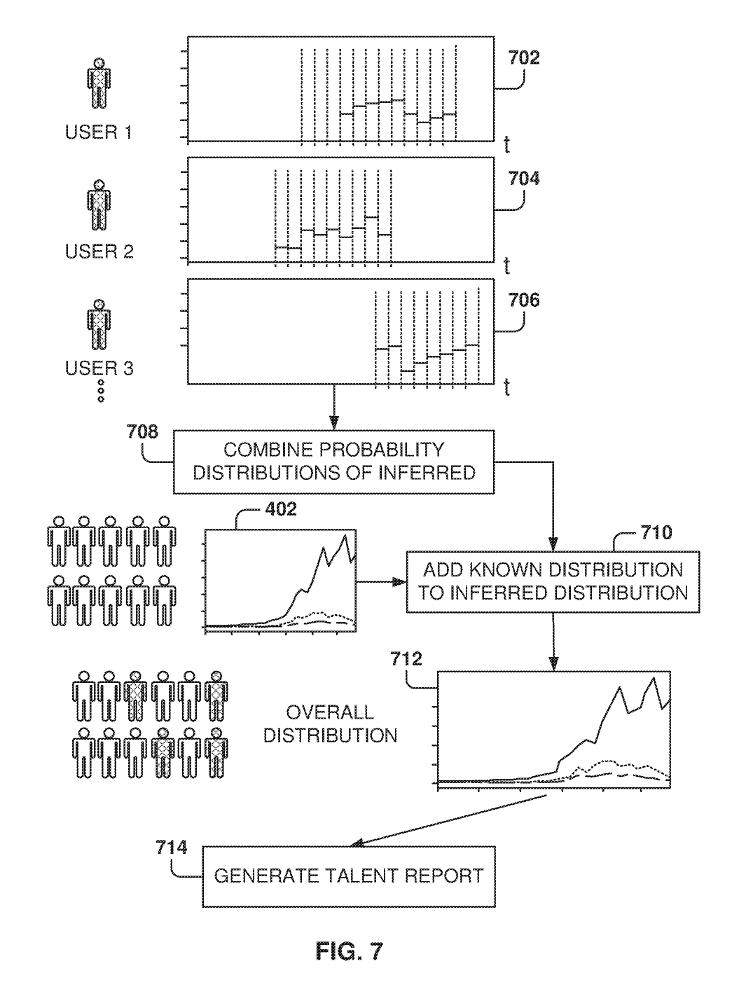

FIG. 7 illustrates the merging of the known start dates with the inferred start-date probabilities to create an overall distribution that may be used for generating a talent report, according to some example embodiments. The probability distribution of the members with an inferred probability distribution are combined. In some example embodiments, combining the probability distributions includes adding the probabilities for all the members by time period to determine the number of people hired in that period.

In a way, the probability is translated into a count, meaning that if a user has a probability of 20% to join in a given period, it is assumed that 0.2 people joined in that given period. This way, the members without start dates are distributed in a way that preserves, as close as possible, the distribution of the members with known start dates.

For example, if in the third quarter of 2015 the probabilities for three users are 0.6, 0.3, and 0.4, the number of people hired in this quarter will be assigned as 1.3. In some example embodiments, the number is then rounded off to the nearest integer in order to avoid having a fractional number of hires.

At operation 710, the combined count for the members with unknown start dates is then combined with the distribution 402 of the members with known start dates to obtain the overall distribution 712 for all the members.

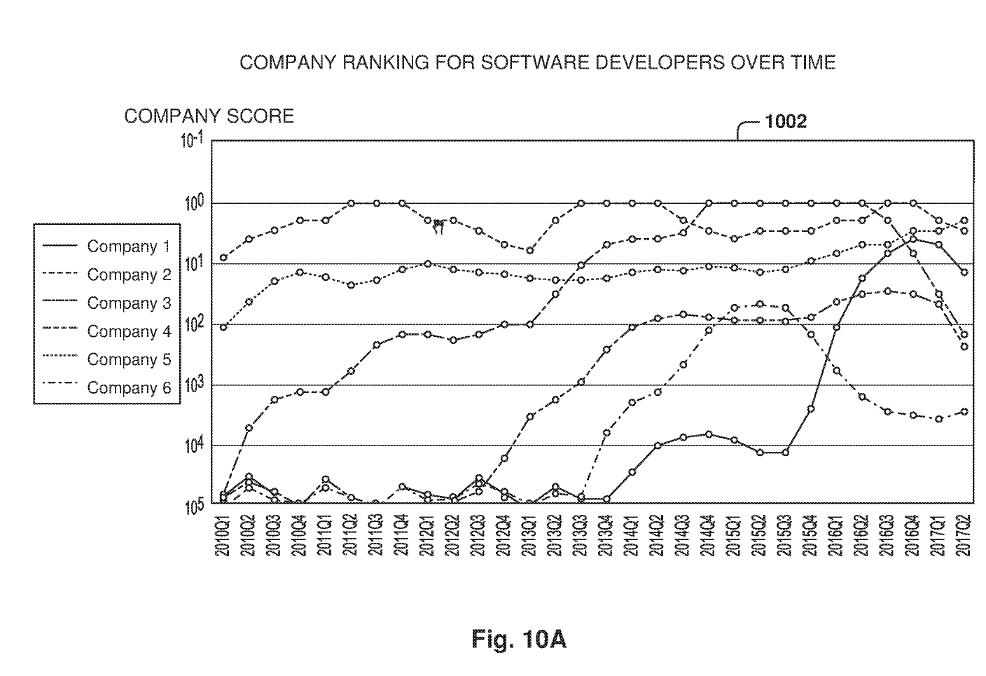

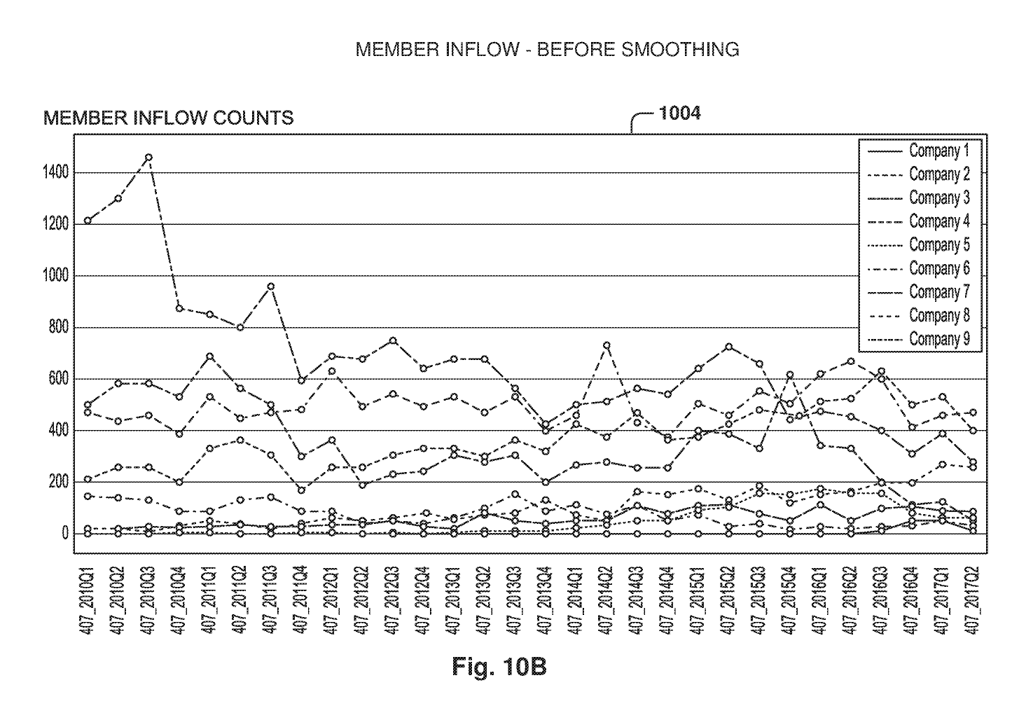

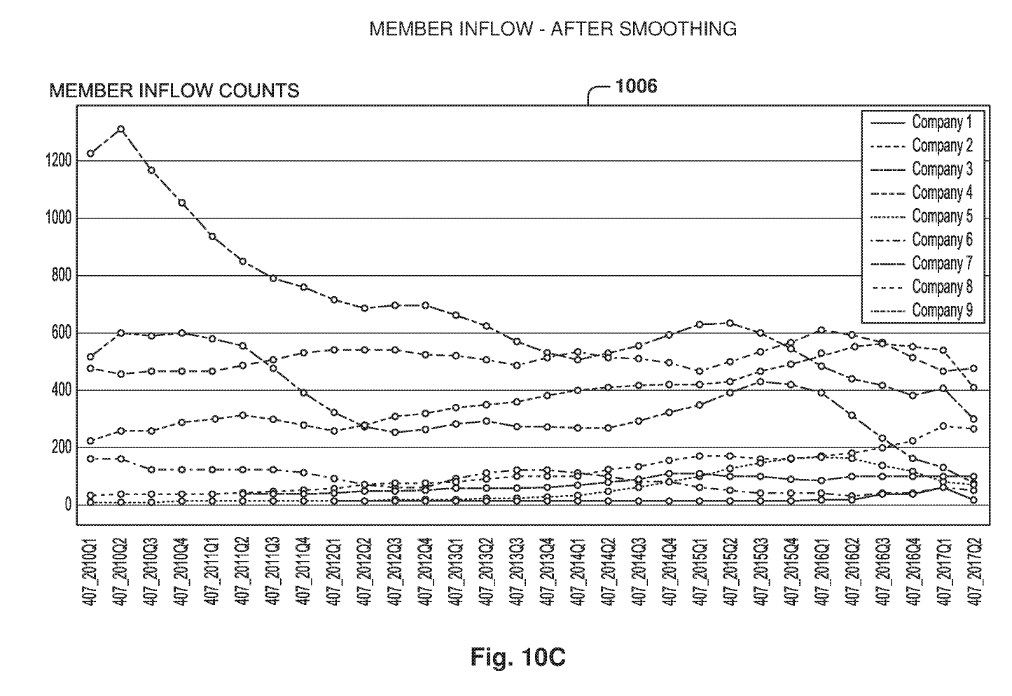

Once the overall distribution 712 is obtained, one or more talent reports are generated at operation 714. Examples of talent reports are provided below with reference to FIGS. 10A-19.

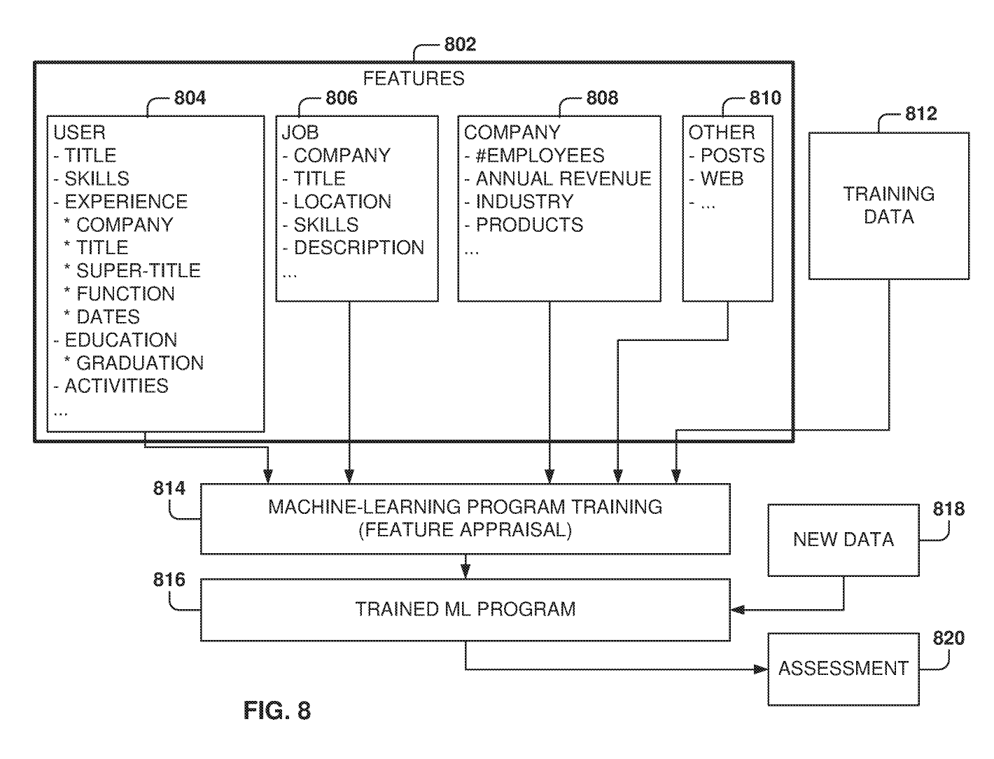

FIG. 8 illustrates the training and use of a machine-learning program, according to some example embodiments. In some example embodiments, machine-learning programs (MLP), also referred to as machine-learning algorithms or tools, are utilized to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 812 in order to make data-driven predictions or decisions expressed as outputs or assessments 820. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms utilize the training data 812 to find correlations among identified features 802 that affect the outcome.

The machine-learning algorithms utilize features for analyzing the data to generate assessments 820. A feature 802 is an individual measurable property of a phenomenon being observed. The concept of feature is related to that of an explanatory variable used in statistical techniques such as linear regression. Choosing informative, discriminating, and independent features is important for effective operation of the MLP in pattern recognition, classification, and regression. Features may be of different types, such as numeric, strings, and graphs.

In one example embodiment, the features 802 may be of different types and may include one or more of user features 804, job features 806, company features 808, and other features 810. The user features 804 may include one or more of the data in the user profile 804 such as title, skills, experience, experience, education, activities, endorsements, and the like. The job features 806 may include any data related to the job, and the company features 808 may include any data related to the company. In some example embodiments, other features 810 may be included, such as post data, message data, web data, and the like.

The machine-learning algorithms utilize the training data 812 to find correlations among the identified features 802 that affect the outcome or assessment 820. In some example embodiments, the training data 812 includes known data for one or more identified features 802 and one or more outcomes, such as jobs searched by users, job suggestions selected for reviews, users changing companies, users adding social connections, users' activities online, and the like.

With the training data 812 and the identified features 802, the machine-learning tool is trained at operation 814. The machine-learning tool appraises the value of the features 802 as they correlate to the training data 812. The result of the training is the trained machine-learning program 816.

When the machine-learning program 816 is used to perform an assessment, new data 818 is provided as an input to the trained machine-learning program 816, and the machine-learning program 816 generates the assessment 820 as output. For example, when a user performs a job search, a machine-learning program, trained with social network data, utilizes the user data and the job data, from the jobs in the database, to search for jobs that match the user's profile and activity.

In some example embodiments, the member positions that have explicitly set start dates (both year and month) are used as the training set and the validation set. For example, 90% of the data is used to train the machine-learning program and 10% is reserved for testing and validation.

In some example embodiments, the machine-learning program may be utilized to determine the probability distributions discussed above. In another example embodiments, the machine-learning program may be utilized to calculate the overall probability distributions, including members with known and unknown start dates, based on the training data. For example, if a report is requested for a given company and a given time period, the machine-learning program utilizes user data (e.g., data associated with features 802) to calculate the overall distribution.

In some example embodiments, the reports may be limited to avoid identifying a small number of users, which could lead to the identification of those users, in order to protect their privacy. For example, reports may require that at least 50 people are included in the report for generating charts and statistics.

In other example embodiments, the machine-learning program may be utilized to predict the start date for a particular member. The machine-learning program is able to examine a great variety of features to better identify the start date. For example, the machine-learning program may take into consideration other dates when the user was employed, dates when the user was engaging actively responding to job posts, messages sent within the network to hiring managers, etc. This way, the machine-learning program may detect that the user was actively searching for jobs for a period of time until the user stopped searching, which is a strong signal that the user found a job in that time period, which then may be associated with the start date of employment. Further, if there is a position assumed to be between graduation and another position, the machine-learning program may infer that there is a higher probability that the start date was close to graduation instead of being close to the start date of another job.

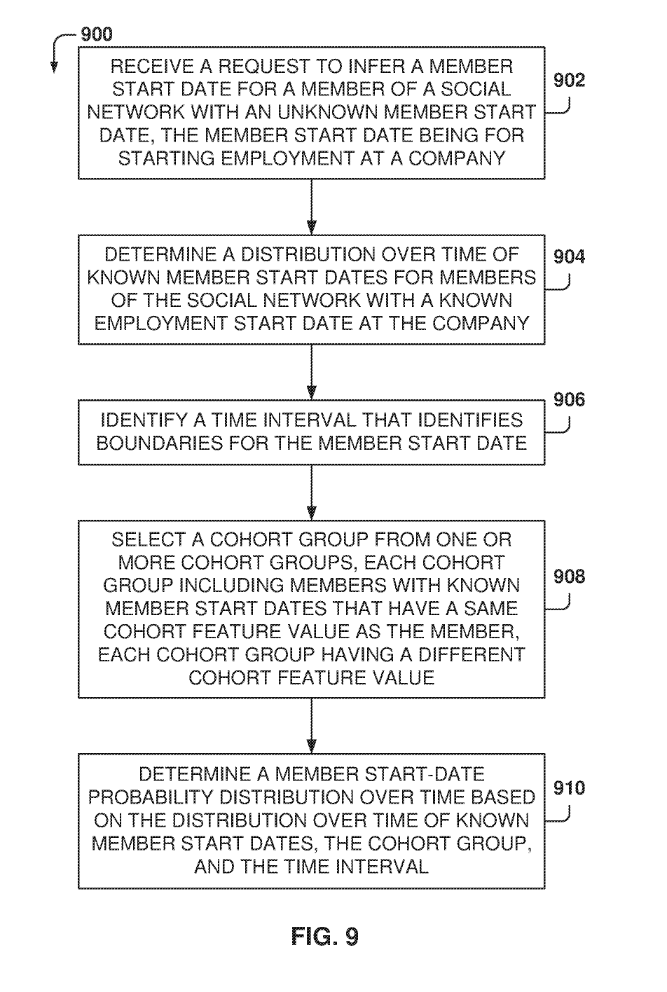

FIG. 9 is flowchart of a method 900 for determining employment start date for members of a social network that have not indicated their employment start date in their profiles in order to generate employment market reports, according to some example embodiments.

Operation 902 is for receiving a request to infer a member start date for a member of a social network with an unknown member start date, the member start date being for starting employment at a company. From operation 902, the method flows to operation 904 for determining a distribution over time of known member start dates for members of the social network with a known employment start date at the company.

From operation 904, the method flows to operation 906 where a time interval that identifies boundaries for the member start date is identified. From operation 906, the method flows to operation 908 where a cohort group is selected from one or more cohort groups. Each cohort group includes members with known member start dates that have a same cohort feature value as the member, and each cohort group has a different cohort feature value.

At operation 910, a member start-date probability distribution over time is determined based on the distribution over time of known member start dates, the cohort group, and the time interval.

In some example embodiments, the operations of the method are executed by one or more processors.

In one example, the method 900 further comprises receiving a request for a report based on start dates of employees of the company, determining the member start-date probability distributions for the company employees with unknown member start dates, and combining the distribution over time of known member start dates with the member start-date probability distributions to generate the report.

In one example, the report is for a distribution of hires for the company per quarter.

In one example, selecting the cohort group further comprises: for each cohort group, determining members of the cohort group as members of the social network having known member start dates and the cohort feature value; determining a number of members in each cohort group; and selecting the cohort group that has a most specific cohort feature from the cohort groups having the number of members above a predetermined threshold.

In one example, the cohort groups comprise a first cohort group having a cohort feature as a company identifier, a second cohort group having a cohort feature as a company identifier and a function within the company, and a third cohort group having a cohort feature as a company identifier and a title of the member.

In one example, identifying the time interval further comprises identifying the time interval based on one or more of a graduation date, dates of employment at other companies, and date the member posted employment at the company in the social network.

In one example, the time interval is between a graduation date and a date the member posted employment at the company in the social network.

In one example, determining the member start-date probability distribution further comprises determining a distribution of the selected cohort group over time, and limiting the distribution of the selected cohort group over time to the identified time interval.

In one example, determining the distribution over time of known member start dates for members of the social network further comprises counting a number of members of the social network with known member start dates per time period.

In one example, determining the member start-date probability distribution is performed by a machine-learning program utilizing features of members of the social network, the machine-learning program being trained with data regarding members of the social network with the known employment start dates.

FIG. 10A is a chart 1002 showing the evolution of the company score over time for several companies, according to some example embodiments. Many reports may be generated based on the company scores and the flow of employees between companies. The reports may include graphical representations in different formats, such as numerical, textual, tabular, or graphical representations of the data. Additionally, multiple report options are available for generating the reports, such as filtering options that may include super-title, geography, time periods, company characteristics, etc. For example, some reports may include the top ten companies by number of employees in a given super-title category, or a predefined number of companies selected by the user, or companies with the biggest company score change, etc.

The generated reports are valuable because they can present information previously unavailable, such as information regarding employee growth rates, attrition rates, transfer of employees between companies, geographic locations of desired-skills employees, etc. It is noted that most companies do not announce this level of detail for their employees. But by analyzing the social network data, it is possible to get detailed employee statistical data, and because of the data architecture, it is possible to get these reports in real time, without having to scan all the data in the social network every time a report is requested, which could take minutes, hours, or even days.

For example, for a startup company that is not public yet, and that may be operating in “stealth” mode (e.g., sharing little information with the community), it is possible to start finding out that the company is attracting certain type of skills, high-talent workers, growing the employee base at the rapid growth, hiring engineers in some cities and salespeople in other cities, etc. For a financial investor and for a competitor, this type of information may be invaluable since no other financial data may be available to assess the company.

Chart 1002 shows the evolution of the company score, which is a metric indicating if the company is adding or losing employees and how well the company is able to retain existing employees over time. Tracking the company score over time, as illustrated in chart 1002, provides valuable insights into the evolution of a company, because the evolution of the workforce may reflect the financial evolution of the company. For example, companies in financial distress may start terminating employees to save money, and companies in expansion periods may show an increase in the number of employees. A financial analyst may see these trends and decide how to invest or divest from certain companies. This is why the company score may have critical importance for financial investors and company management. Additionally, if a manager identifies that employees are leaving for other companies, the manager may look at the market job trends to increase compensation and be able to retain employees.

In chart 1002, the horizontal axis covers data by quarter, and the vertical axis corresponds to the company score in an inverse logarithmic scale (scores at the bottom are close to 0 and the maximum score is 1).

From chart 1002, the evolution of the companies over time can be easily observed. For example, Company 1 started growing in the fourth quarter of 2013 and saw a very accelerated growth starting at the third quarter of 2015, although it has shown some decrease in the score in the last two quarters. Further, Company 2 has steady growth and thus a high score over the seven years covered in the chart 1002. Company 3 showed gradual growth until it reached the maximum score, but has showed rapid decline over the last four quarters. Company 6 showed rapid growth starting in 2013, but in the third quarter of 2015, the company suffered a large decrease. It is noted that the company score for Company 6 started showing the decline a couple of quarters before Company 6 announced regulatory problems.

FIG. 10B is a report representing employee inflow over time for a plurality of companies before smoothing, according to some example embodiments. Chart 1004 shows the inflow of employees, per quarter, for a plurality of companies. It is easy to visually analyze how companies grow or shrink over time. Each point in the graph represents the inflow in a particular quarter for the company, and these points are joined by a line to show the evolution.

The chart 1004 of FIG. 10B includes the top nine companies with respect to new employees. Other charts may include the number of outgoing employees, or the net gain or loss of employees.

FIG. 10C is a report representing employee inflow over time for a plurality of companies after smoothing, according to some example embodiments. As seen in FIG. 10B, the inflow data may include many abrupt spikes and valleys. In some example embodiments, data smoothing techniques are utilized to smooth the data over time, such as by calculating a weighted average over a predetermined number of periods, which could extend to the previous periods and future periods.

In one example embodiment, the smoothed inflow count numbers are calculated as:

$${I}_{t} = \frac{1}{8} {x}_{t - 2} + \frac{1}{4} {x}_{t - 1} + \frac{1}{4} {x}_{t} + \frac{1}{4} {x}_{t + 1} + \frac{1}{8} {x}_{t + 2}$$

Iₜ represents the weighted smoothed inflow for the period t being calculated, and xᵢ corresponds to the inflow for the period t, where period t−1 is the previous period, period t+1 is the next period, etc. In some example embodiments. Iₜ is used instead of the inflow for the period for the calculation of the company score. Other embodiments may utilize different periods and different weights for the weighted-sum calculation, such as using the current period and the previous two periods, etc., or other exponential smoothing techniques may be utilized.

FIG. 10C shows the inflow chart 1006 after smoothing. In this case, it is easier to appreciate trends over a period of time as the lines tend to include less spikes and valleys.

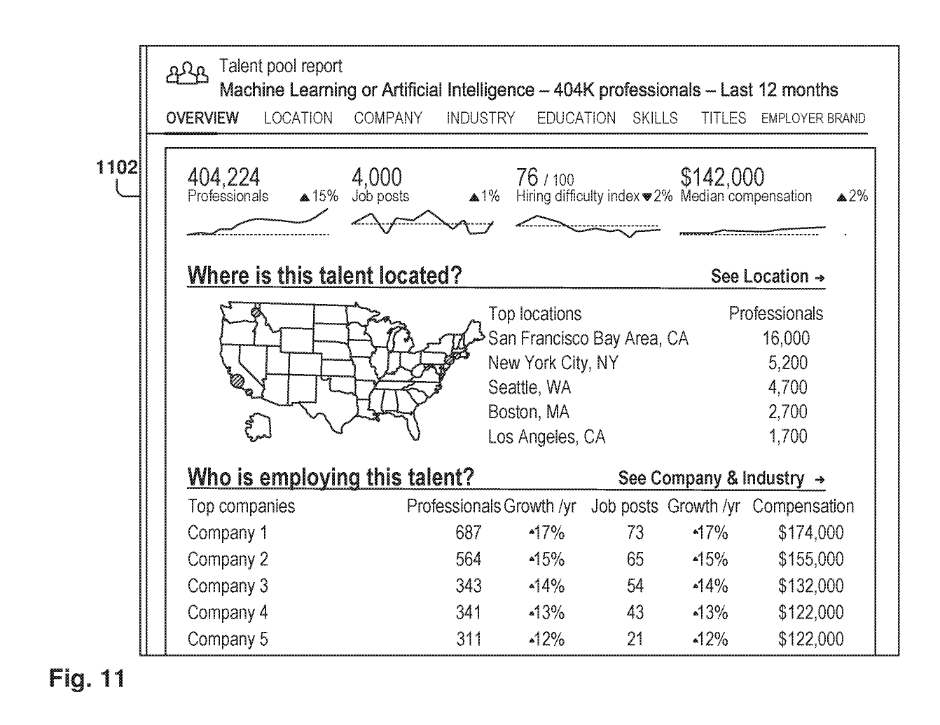

FIG. 11 is a talent pool report 1102, according to some example embodiments. A talent pool report is a type of report that enables finding any population of talent, based on skills, titles, geographies, and industries, while providing insights to help create a talent-acquisition strategy. For example, if the company wants to hire 200 engineers with machine-learning skills, the company may conduct a search to identify where the talent with machine-learning skills is located. This helps the company decide in which locations to hire and establish working teams, or at which locations it will be more expensive to hire employees.

The talent pool report 1102 is an example for a super-title of machine learning or artificial intelligence for the last 12 months. The report 1102 indicates that there are 404,224 professionals that match this skill in the geography of interest, the United States in this case.

The report 1102 includes numbers and graphical representation of the evolution of the professionals, the number of job posts identified in this period for machine learning, a hiring difficulty index, and the median compensation (together with respective growth indicators over the previous year).

Additionally, a map of the United States is shown with circles of varying sizes in proportion to the number of employees at the location, for the identified super-title or super-titles. Additionally, a table shows the tabular representation for the locations and the number of professionals in these locations.

Further yet, the report 1102 includes a list of companies (e.g., top five) that are hiring this type of employee and a table is provided indicating, by company, the number of professionals employed at the company, the percentage growth by year, the number of job posts, the growth by each year in the number of job posts, and the median compensation.

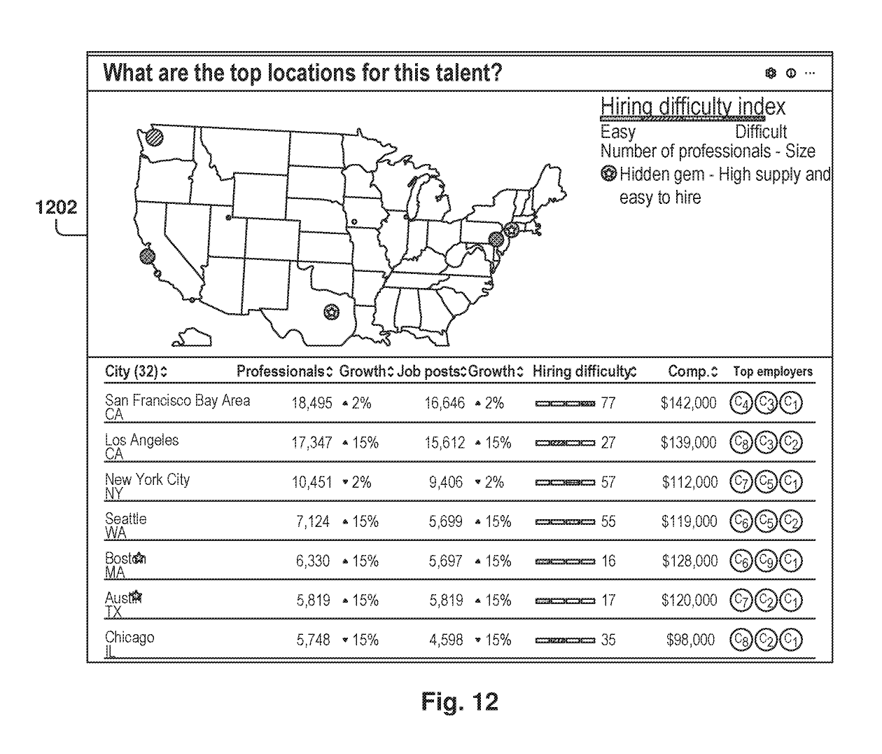

FIG. 12 is a talent geographic map 1202, according to some example embodiments. Supply indicates how many employees are available while demand shows how many companies are hiring for the given super-title. By analyzing supply and demand, it is possible to identify geographies where the number of open job positions is much higher than the supply of skilled workers to field those jobs. In this case, there is a shortage and it will be difficult to hire in that location, or it will be expensive.

In addition, knowing which companies have these workers allows the hiring manager to identify competition for this type of talent. Also, it is possible to see attrition at a company. In this case, employees at this company may be receptive to discussing employment opportunities.

The map 1202 illustrates the top locations for this type of talent. The map 1202 includes circles that are colored based on the hiring difficulty index. Thus, there may be some circles indicating where it is difficult to hire, or other circles that indicate “hidden gems” with a large supply of the desired employees.

A table beneath the map 1202 shows data by location, indicating the number of professionals in the area, the annual growth in number of professionals, the number of job posts, the growth in job posts, a hiring difficulty index based on the supply and demand for the region, average compensation, and the top employers in the region (e.g., C₄, C₃, C₁), which may be represented by name, logo, or both.

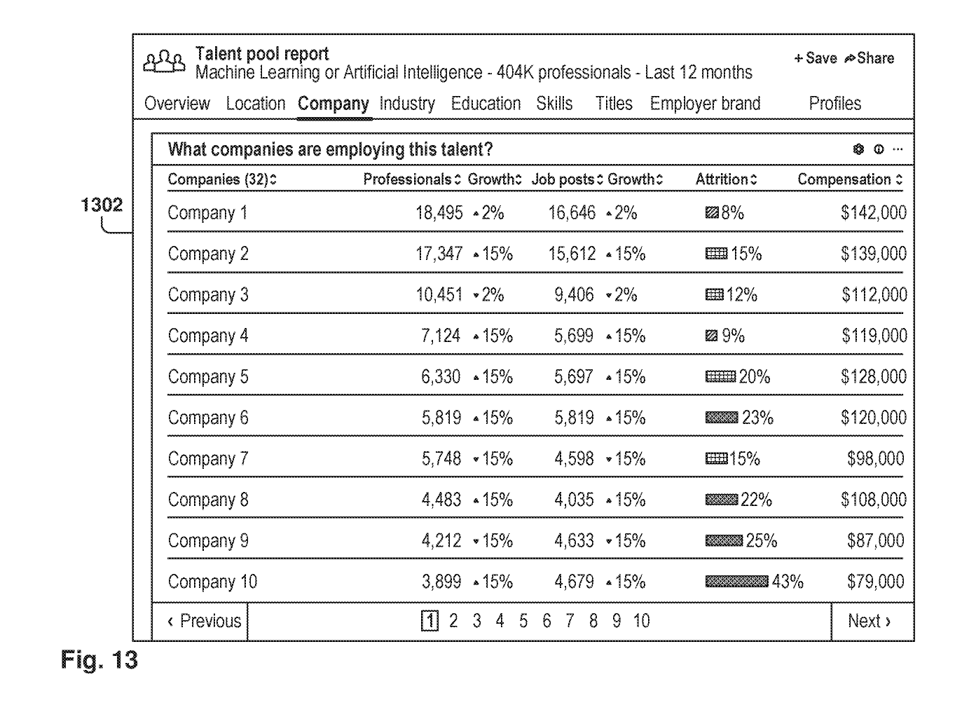

FIG. 13 is a talent-distribution report by company, according to some example embodiments. Chart 1302 shows the companies that are employing machine-learning employees. The data is represented in a table, similar to the table in FIG. 12, but instead of a hiring difficulty index, a column with the attrition rate is provided. The attrition rate is represented numerically and as a graphical horizontal bar that is color-coded based on the attrition rate. For example, company 10 has shown a 43% attrition rate over the last year, indicating that the talent is leaving that company.

It is noted that the report includes 32 companies, although only 10 are presented; however, scrolling options are provided in the user interface for showing additional companies.

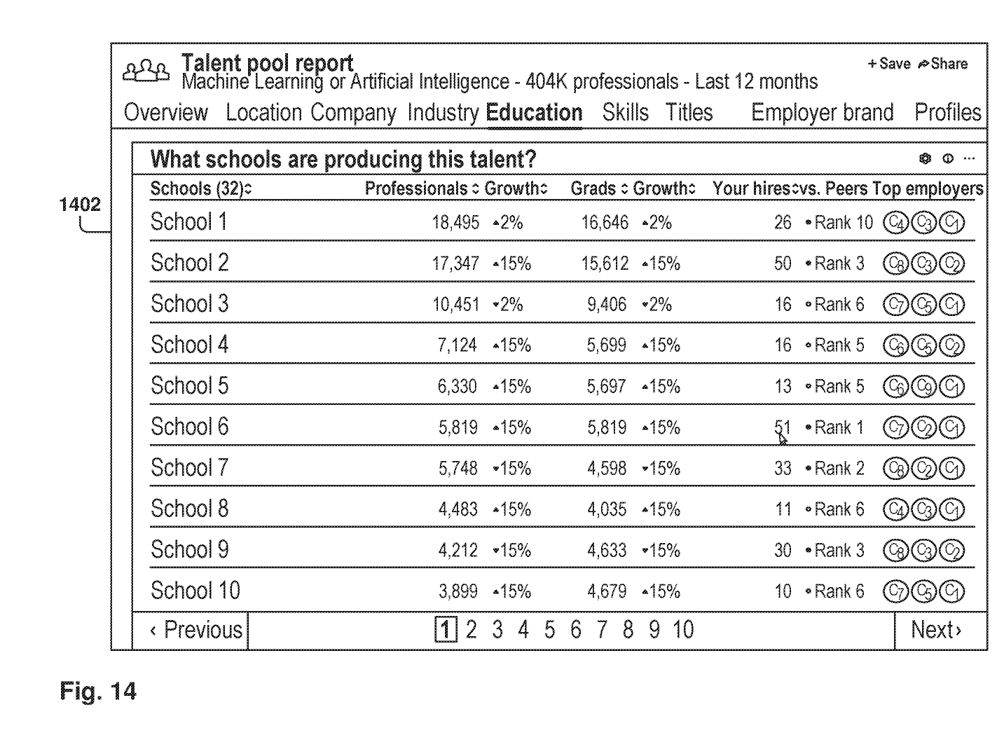

FIG. 14 is a talent report by educational institution, according to some example embodiments. It may also be very informative for a hiring manager to know which schools are providing the desired skills, especially for recent graduates. This way, the hiring manager may intensify hiring activities at the schools generating a large number of graduates with the desired skills.

Chart 1402 shows a talent pool report for the schools “producing” this type of talent. The table includes an entry for each school, and each entry includes the number of professionals who show in their profiles that they are graduates from the school, the annual percentage growth in the number of professionals, the number of recent graduates, the annual growth in the number of recent graduates, the number of hires for the company generating the report, ranking versus other peers, and the top employers indicated by their logos, although other embodiments may include their name. Chart 1402 includes 10 schools (e.g., universities) and scrolling options are provided to show additional schools.

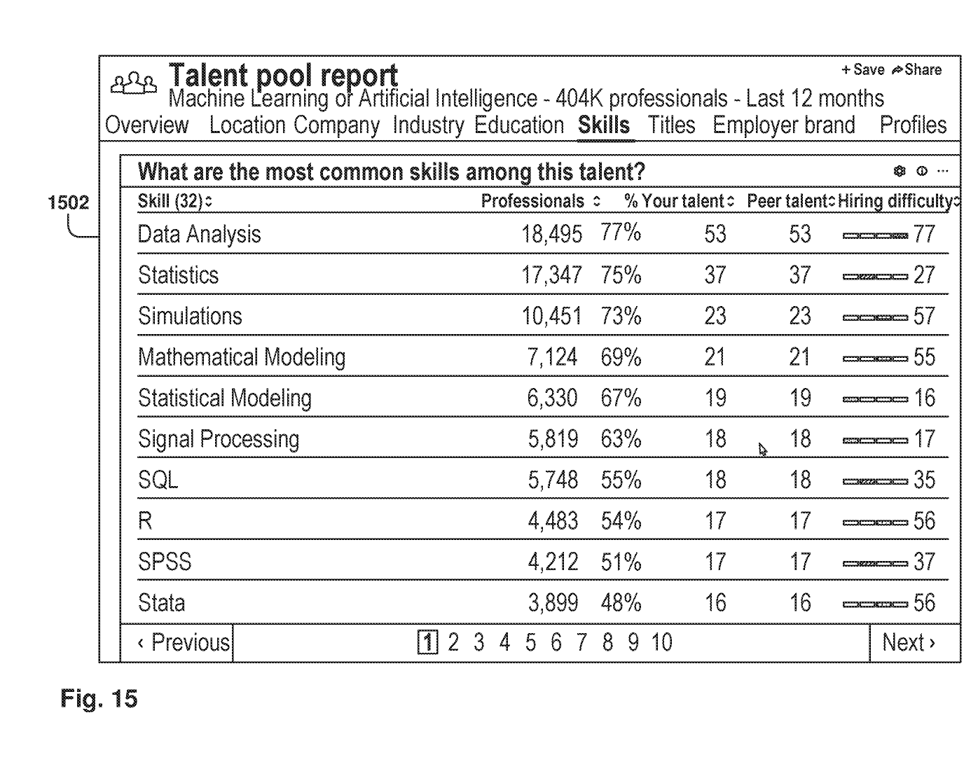

FIG. 15 is a talent report by user skill, according to some example embodiments. Sometimes, it may be difficult to hire the right person for a job, but it may be possible to hire people with similar skills and provide training and mentoring to get the desired skills. Therefore, an analysis of the skills identified by users in the profile may assist in targeting similar types of talent.

Chart 1502 represents the most common skills for a given talent (e.g., machine learning or artificial intelligence). The table includes an entry for each skill and is sorted by the number of professionals showing this skill within the target group. For each entry, the number of professionals identifying the skill is shown, as well as the percentage growth in the number of professionals, the number of employees of the present company showing this skill, the number of peers showing this skill, and the hiring difficulty for hiring employees that possess this skill. The hiring difficulty may be represented as a number and as a sliding scale.

For example, for machine learning, Data Analysis is identified as the most common skill, followed by Statistics, Simulations, Mathematical Modeling, Statistical Modeling, Signal Processing, etc. The table shows that hiring Data Analysis skills is relatively difficult, with a hiring difficulty of 77%. However, people with Statistical Modeling and Signal Processing have relatively low hiring difficulty ratios, so the hiring manager may decide to hire engineers with Statistical Modeling skills and train them to become data scientists.

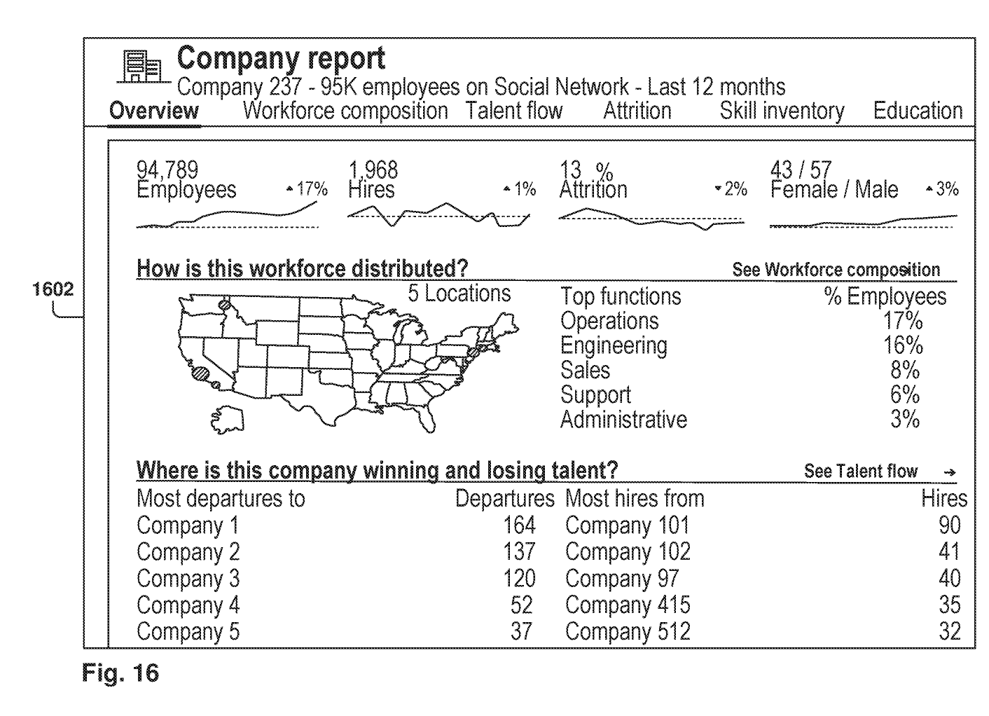

FIG. 16 is a workforce-distribution report for a company, according to some example embodiments. The company report for a particular company (e.g., Company 237 in this example) provides information about the labor composition of the company.

The company report 1602 shows that Company 237 has 94,789 employees with profiles in the social network over the last 12 months. The report 1602 further includes the number of employees, the number of hires, the attrition rate, and the ratio of female to male, with respective linear graphical representations of these values.

Additionally, the company report 1602 shows how the workforce is distributed for this company, illustrated by a map of the United States with circles proportional in size to the concentration of employees. A table next to the map also breaks down the percentage of employees by function, such as Operations, Engineering, Sales, Support, and Administrative.

Further below, a couple of tables indicate where the company is winning and losing talent. A first table on the left shows the companies where employees of Company 237 are going and the number of departures; and a second table on the right shows the companies from which Company 237 is hiring, together with the number of hires within the last 12 months. Company report 1602 provides a dashboard of information for the company as well as some information about competitors for talent.

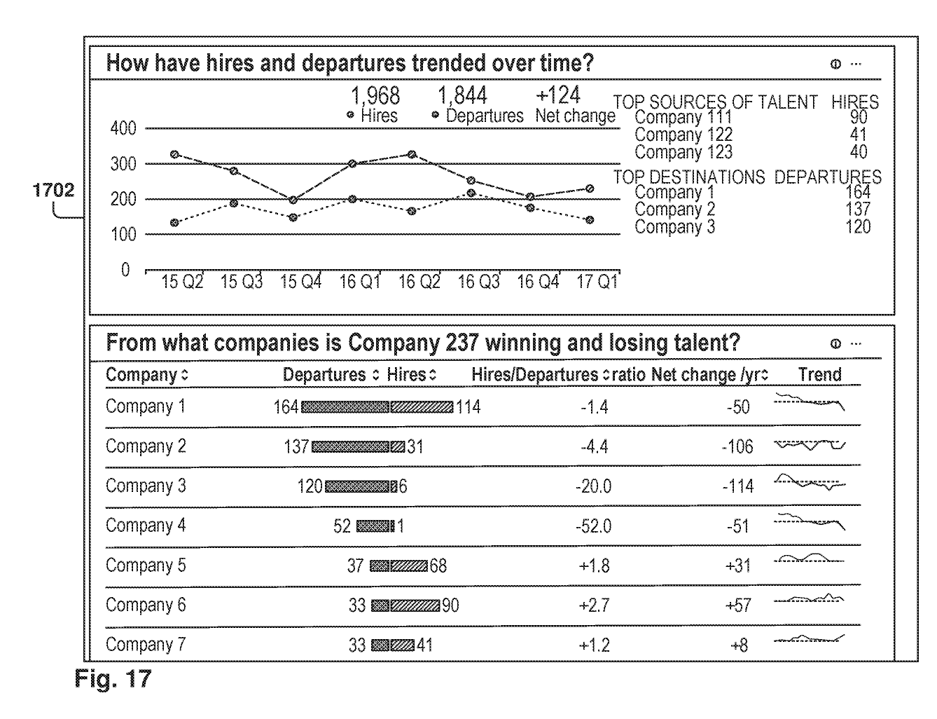

FIG. 17 is a timeline for hires and departures of a given company, according to some example embodiments. Chart 1702 illustrates hires and departure data over time. A top chart shows lines for the number of hires and the number of departures by quarter. Additionally, the companies that are the top sources for talent and the top destinations are shown in tabular form on the right, including the number of hires or departures.

Further, a mixed tabular and graphical summary is presented below to indicate from what companies is Company 237 winning and losing talent. The table includes one entry per company, and for each company a comparison of the departures and hires, a hires-to-departure ratio, a net change per year for hires or departures (color coded: red for losing talent and black for gaining talent), and a historical line showing evolution over time.

The departures-versus-hires column includes a bar with an origin point. The size of the bar grows to the left in proportion to the number of departures and grows to the right in proportion to the number of hires. Additionally, the actual number of departures or hires is shown next to the bar. This is a very useful graphical representation because it is very easy to quickly see how the company is gaining or losing employees to the respective company in the chart. For example, it is clear to see that Company 237 is losing employees to companies 1-4 but gaining employees with reference to companies 5-7.

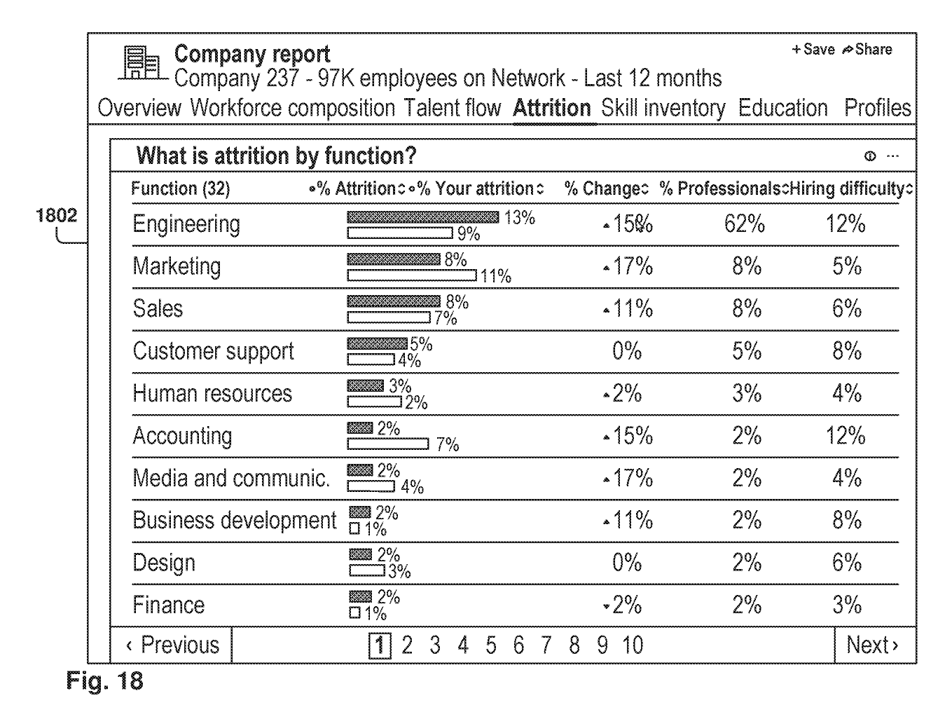

FIG. 18 is a company report by function, according to some example embodiments. Chart 1802 is a company report for a given company (Company 237) that shows the attrition by function. The data is represented in a tabular form with one entry for each function, which include Engineering, Marketing, Sales, Customer support, Human resources, etc.

For each function, two bars are presented, one bar for the attrition rate for the market and another bar for the attrition rate of the company. Other fields include the percentage change in the number of employees, the percentage of professionals within the company, and a hiring difficulty index for the function.

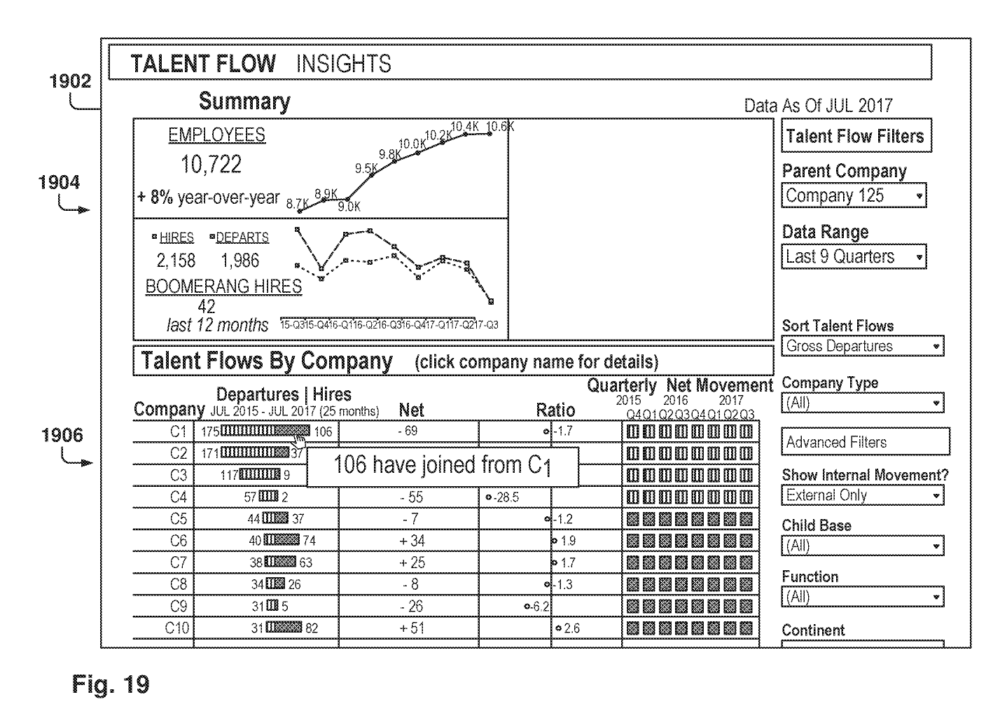

FIG. 19 is a report for talent flow between companies, according to some example embodiments. FIG. 19 provides a dashboard 1902 for talent flow insights. A top section 1904 includes a summary with charts for the number of employees over time, and the number of hires and departures over time. The charts show that the number of employees have steadily grown over time, but that in recent times the number of hires and departures are similar, indicating lack of employee growth at the company.

Further, a bottom section 1906 indicates how the talent flows by company. The table includes an entry for each company with hires or departures with respect to Company 237, and includes the double horizontal bar for departures and hires, as described above with reference to FIG. 17. As shown, if a mouse is placed over the bar, additional information is provided. Other columns indicate the net gain of employees, the ratio between hires and departures, and a color-coded representation of the inflow or outflow, by quarter.

For each quarter, a color-coded square shows an indication of the employee flow. For example, the squares for the first entry for company C₁, show a prevalent red color, which indicates that the company has been losing employees to company C₁. On the other hand, the squares for company C₁₀ are mainly green, indicating that the company has been gaining talent from C₁₀.

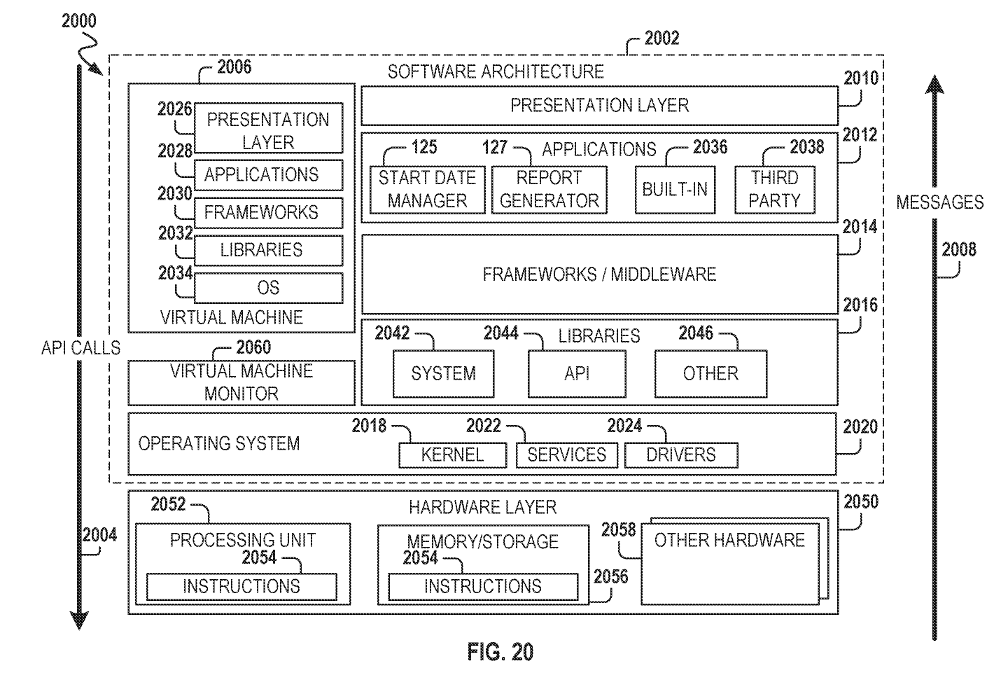

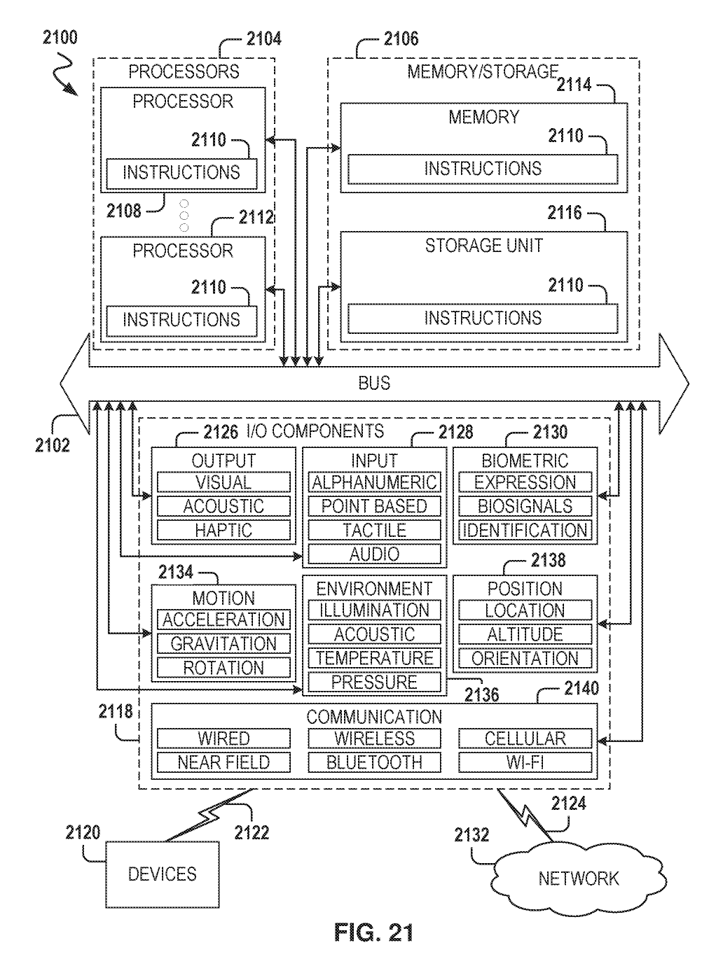

FIG. 20 is a block diagram 2000 illustrating a representative software architecture 2002, which may be used in conjunction with various hardware architectures herein described. FIG. 20 is merely a non-limiting example of a software architecture 2002, and it will be appreciated that many other architectures may be implemented to facilitate the functionality described herein. The software architecture 2002 may be executing on hardware such as a machine 2100 of FIG. 21 that includes, among other things, processors 2104, memory/storage 2106, and input/output (I/O) components 2118. A representative hardware layer 2050 is illustrated and may represent, for example, the machine 2100 of FIG. 21. The representative hardware layer 2050 comprises one or more processing units 2052 having associated executable instructions 2054. The executable instructions 2054 represent the executable instructions of the software architecture 2002, including implementation of the methods, modules, and so forth of FIGS. 1-9. The hardware layer 2050 also includes memory and/or storage modules 2056, which also have the executable instructions 2054. The hardware layer 2050 may also comprise other hardware 2058, which represents any other hardware of the hardware layer 2050, such as the other hardware illustrated as part of the machine 2100.

In the example architecture of FIG. 20, the software architecture 2002 may be conceptualized as a stack of layers where each layer provides particular functionality. For example, the software architecture 2002 may include layers such as an operating system 2020, libraries 2016, frameworks/middleware 2014, applications 2012, and a presentation layer 2010. Operationally, the applications 2012 and/or other components within the layers may invoke application programming interface (API) calls 2004 through the software stack and receive a response, returned values, and so forth illustrated as messages 2008 in response to the API calls 2004. The layers illustrated are representative in nature, and not all software architectures have all layers. For example, some mobile or special-purpose operating systems may not provide a frameworks/middleware 2014 layer, while others may provide such a layer. Other software architectures may include additional or different layers.

The operating system 2020 may manage hardware resources and provide common services. The operating system 2020 may include, for example, a kernel 2018, services 2022, and drivers 2024. The kernel 2018 may act as an abstraction layer between the hardware and the other software layers. For example, the kernel 2018 may be responsible for memory management, processor management (e.g., scheduling), component management, networking, security settings, and so on. The services 2022 may provide other common services for the other software layers. The drivers 2024 may be responsible for controlling or interfacing with the underlying hardware. For instance, the drivers 2024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2016 may provide a common infrastructure that may be utilized by the applications 2012 and/or other components and/or layers. The libraries 2016 typically provide functionality that allows other software modules to perform tasks in an easier fashion than by interfacing directly with the underlying operating system 2020 functionality (e.g., kernel 2018, services 2022, and/or drivers 2024). The libraries 2016 may include system libraries 2042 (e.g., C standard library) that may provide functions such as memory allocation functions, string manipulation functions, mathematic functions, and the like. In addition, the libraries 2016 may include API libraries 2044 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 2016 may also include a wide variety of other libraries 2046 to provide many other APIs to the applications 2012 and other software components/modules.

The frameworks 2014 (also sometimes referred to as middleware) may provide a higher-level common infrastructure that may be utilized by the applications 2012 and/or other software components/modules. For example, the frameworks 2014 may provide various graphic user interface (GUI) functions, high-level resource management, high-level location services, and so forth. The frameworks 2014 may provide a broad spectrum of other APIs that may be utilized by the applications 2012 and/or other software components/modules, some of which may be specific to a particular operating system or platform.

The applications 2012 include the start date manage 125, the report generator 127, and other modules as shown in FIG. 1 (not shown), built-in applications 2036, and third-party applications 2038. Examples of representative built-in applications 2036 may include, but are not limited to, a contacts application, a browser application, a book reader application, a location application, a media application, a messaging application, and/or a game application. The third-party applications 2038 may include any of the built-in applications 2036 as well as a broad assortment of other applications. In a specific example, the third-party application 2038 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 2038 may invoke the API calls 2004 provided by the mobile operating system such as the operating system 2020 to facilitate functionality described herein.

The applications 2012 may utilize built-in operating system functions (e.g., kernel 2018, services 2022, and/or drivers 2024), libraries (e.g., system libraries 2042, API libraries 2044, and other libraries 2046), or frameworks/middleware 2014 to create user interfaces to interact with users of the system. Alternatively, or additionally, in some systems, interactions with a user may occur through a presentation layer, such as the presentation layer 2010. In these systems, the application/module “logic” may be separated from the aspects of the application/module that interact with a user.

Some software architectures utilize virtual machines. In the example of FIG. 20, this is illustrated by a virtual machine 2006. A virtual machine creates a software environment where applications/modules may execute as if they were executing on a hardware machine (such as the machine 2100 of FIG. 21, for example). The virtual machine 2006 is hosted by a host operating system (e.g., the operating system 2020 in FIG. 20) and typically, although not always, has a virtual machine monitor 2060, which manages the operation of the virtual machine 2006 as well as the interface with the host operating system (e.g., the operating system 2020). A software architecture executes within the virtual machine 2006, such as an operating system 2034, libraries 2032, frameworks/middleware 2030, applications 2028, and/or a presentation layer 2026. These layers of software architecture executing within the virtual machine 2006 may be the same as corresponding layers previously described or may be different.

FIG. 21 is a block diagram illustrating components of a machine 2100, according to some example embodiments, able to read instructions from a machine-readable medium (e.g., a machine-readable storage medium) and perform any one or more of the methodologies discussed herein. Specifically, FIG. 21 shows a diagrammatic representation of the machine 2100 in the example form of a computer system, within which instructions 2110 (e.g., software, a program, an application, an applet, an app, or other executable code) for causing the machine 2100 to perform any one or more of the methodologies discussed herein may be executed. For example, the instructions 2110 may cause the machine 2100 to execute the flow diagrams of FIGS. 5-9. Additionally, or alternatively, the instructions 2110 may implement the programs of the social networking server 112, and so forth. The instructions 2110 transform the general, non-programmed machine 2100 into a particular machine 2100 programmed to carry out the described and illustrated functions in the manner described.

In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2110, sequentially or otherwise, that specify actions to be taken by the machine 2100. Further, while only a single machine 2100 is illustrated, the term “machine” shall also be taken to include a collection of machines 2100 that individually or jointly execute the instructions 2110 to perform any one or more of the methodologies discussed herein.

The machine 2100 may include processors 2104, memory/storage 2106, and I/O components 2118, which may be configured to communicate with each other such as via a bus 2102. In an example embodiment, the processors 2104 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2108 and a processor 2112 that may execute the instructions 2110. The term “processor” is intended to include multi-core processors that may comprise two or more independent processors (sometimes referred to as “cores”) that may execute instructions contemporaneously. Although FIG. 21 shows multiple processors 2104, the machine 2100 may include a single processor with a single core, a single processor with multiple cores (e.g., a multi-core processor), multiple processors with a single core, multiple processors with multiple cores, or any combination thereof.

The memory/storage 2106 may include a memory 2114, such as a main memory, or other memory storage, and a storage unit 2116, both accessible to the processors 2104 such as via the bus 2102. The storage unit 2116 and memory 2114 store the instructions 2110 embodying any one or more of the methodologies or functions described herein. The instructions 2110 may also reside, completely or partially, within the memory 2114, within the storage unit 2116, within at least one of the processors 2104 (e.g., within the processor's cache memory), or any suitable combination thereof, during execution thereof by the machine 2100. Accordingly, the memory 2114, the storage unit 2116, and the memory of the processors 2104 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 2110. The term “machine-readable medium” shall also be taken to include any medium, or combination of multiple media, that is capable of storing instructions (e.g., instructions 2110) for execution by a machine (e.g., machine 2100), such that the instructions, when executed by one or more processors of the machine (e.g., processors 2104), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2118 may include a wide variety of components to receive input, provide output, produce output, transmit information, exchange information, capture measurements, and so on. The specific I/O components 2118 that are included in a particular machine will depend on the type of machine. For example, portable machines such as mobile phones will likely include a touch input device or other such input mechanisms, while a headless server machine will likely not include such a touch input device. It will be appreciated that the I/O components 2118 may include many other components that are not shown in FIG. 21. The I/O components 2118 are grouped according to functionality merely for simplifying the following discussion, and the grouping is in no way limiting. In various example embodiments, the I/O components 2118 may include output components 2126 and input components 2128. The output components 2126 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2128 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 2118 may include biometric components 2130, motion components 2134, environmental components 2136, or position components 2138 among a wide array of other components. For example, the biometric components 2130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2134 may include acceleration sensor components (e.g., accelerometer), gravitation sensor components, rotation sensor components (e.g., gyroscope), and so forth. The environmental components 2136 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2118 may include communication components 2140 operable to couple the machine 2100 to a network 2132 or devices 2120 via a coupling 2124 and a coupling 2122, respectively. For example, the communication components 2140 may include a network interface component or other suitable device to interface with the network 2132. In further examples, the communication components 2140 may include wired communication components, wireless communication components, cellular communication components, Near Field Communication (NFC) components, Bluetooth® components (e.g., Bluetooth® Low Energy). Wi-Fi®, components, and other communication components to provide communication via other modalities. The devices 2120 may be another machine or any of a wide variety of peripheral devices (e.g., a peripheral device coupled via a USB).

Moreover, the communication components 2140 may detect identifiers or include components operable to detect identifiers. For example, the communication components 2140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2140, such as location via Internet Protocol (IP) geo-location, location via Wi-Fi® signal triangulation, location via detecting an NFC beacon signal that may indicate a particular location, and so forth.

In various example embodiments, one or more portions of the network 2132 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fit network, another type of network, or a combination of two or more such networks. For example, the network 2132 or a portion of the network 2132 may include a wireless or cellular network and the coupling 2124 may be a Code Division Multiple Access (CDMA) connection, a Global System for Mobile communications (GSM) connection, or another type of cellular or wireless coupling. In this example, the coupling 2124 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 2110 may be transmitted or received over the network 2132 using a transmission medium via a network interface device (e.g., a network interface component included in the communication components 2140) and utilizing any one of a number of well-known transfer protocols (e.g., hypertext transfer protocol (HTTP)). Similarly, the instructions 2110 may be transmitted or received using a transmission medium via the coupling 2122 (e.g., a peer-to-peer coupling) to the devices 2120. The term “transmission medium” shall be taken to include any intangible medium that is capable of storing, encoding, or carrying the instructions 2110 for execution by the machine 2100, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, by one or more processors, a request to infer a member start date for a member of a social network with an unknown member start date, the member start date being for starting employment at a company;
determining, by the one or more processors, a distribution over time of known member start dates for members of the social network with a known employment start date at the company;
identifying, by the one or more processors, a time interval that identifies boundaries for the member start date;
selecting, by the one or more processors, a cohort group from one or more cohort groups, each cohort group including members with known member start dates that have a same cohort feature value as the member, each cohort group having a different cohort feature value; and
determining, by the one or more processors, a member start-date probability distribution over time based on the distribution over time of known member start dates, the cohort group, and the time interval.

2. The method as recited in claim 1, further comprising:
receiving a request for a report based on start dates of employees of the company;
determining the member start-date probability distributions for the company employees with unknown member start dates; and
combining the distribution over time of known member start dates with the member start-date probability distributions to generate the report.

3. The method as recited in claim 2, wherein the report is for a distribution of hires for the company per quarter.

4. The method as recited in claim 1, wherein selecting the cohort group further comprises:
for each cohort group, determining members of the cohort group as members of the social network having known member start dates and the cohort feature value;
determining a number of members in each cohort group; and
selecting the cohort group that has a most specific cohort feature from the cohort groups having the number of members above a predetermined threshold.

5. The method as recited in claim 1, wherein the cohort groups comprise:
a first cohort group having a cohort feature as a company identifier;
a second cohort group having a cohort feature as a company identifier and a function within the company; and
a third cohort group having a cohort feature as a company identifier and a title of the member.

6. The method as recited in claim 1, wherein identifying the time interval further comprises:
identifying the time interval based on one or more of a graduation date, dates of employment at other companies, and date the member posted employment at the company in the social network.

7. The method as recited in claim 1, wherein the time interval is between a graduation date and a date the member posted employment at the company in the social network.

8. The method as recited in claim 1, wherein determining the member start-date probability distribution further comprises:
determining a distribution of the selected cohort group over time; and
limiting the distribution of the selected cohort group over time to the identified time interval.

9. The method as recited in claim 1, wherein determining the distribution over time of known member start dates for members of the social network further comprises:
counting a number of members of the social network with known member start dates per time period.

10. The method as recited in claim 1, wherein determining the member start-date probability distribution is performed by a machine-learning program utilizing features of members of the social network, the machine-learning program being trained with data regarding members of the social network with the known employment start dates.

11. A system comprising:
a memory comprising instructions; and
one or more computer processors, wherein the instructions, when executed by the one or more computer processors, cause the one or more computer processors to perform operations comprising:
receiving a request to infer a member start date for a member of a social network with an unknown member start date, the member start date being for starting employment at a company;
determining a distribution over time of known member start dates for members of the social network with a known employment start date at the company;
identifying a time interval that identifies boundaries for the member start date;
selecting a cohort group from one or more cohort groups, each cohort group including members with known member start dates that have a same cohort feature value as the member, each cohort group having a different cohort feature value; and
determining a member start-date probability distribution over time based on the distribution over time of known member start dates, the cohort group, and the time interval.

12. The system as recited in claim 11, wherein the instructions further cause the one or more computer processors to perform operations comprising:
receiving a request for a report based on start dates of employees of the company;
determining the member start-date probability distributions for the company employees with unknown member start dates; and
combining the distribution over time of known member start dates with the member start-date probability distributions to generate the report.

13. The system as recited in claim 11, wherein selecting the cohort group further comprises:
for each cohort group, determining members of the cohort group as members of the social network having known member start dates and the cohort feature value;
determining a number of members in each cohort group; and
selecting the cohort group that has a most specific cohort feature from the cohort groups having the number of members above a predetermined threshold.

14. The system as recited in claim 11, wherein the cohort groups comprise:
a first cohort group having a cohort feature as a company identifier;
a second cohort group having a cohort feature as a company identifier and a function within the company; and
a third cohort group having a cohort feature as a company identifier and a title of the member.

15. The system as recited in claim 11, wherein identifying the time interval further comprises:
identifying the time interval based on one or more of a graduation date, dates of employment at other companies, and date the member posted employment at the company in the social network.

16. A non-transitory machine-readable storage medium including instructions that, when executed by a machine, cause the machine to perform operations comprising:
receiving a request to infer a member start date for a member of a social network with an unknown member start date, the member start date being for starting employment at a company;
determining a distribution over time of known member start dates for members of the social network with a known employment start date at the company;
identifying a time interval that identifies boundaries for the member start date;
selecting a cohort group from one or more cohort groups, each cohort group including members with known member start dates that have a same cohort feature value as the member, each cohort group having a different cohort feature value; and
determining a member start-date probability distribution over time based on the distribution over time of known member start dates, the cohort group, and the time interval.

17. The machine-readable storage medium as recited in claim 16, wherein the machine further performs operations comprising:
receiving a request for a report based on start dates of employees of the company;
determining the member start-date probability distributions for the company employees with unknown member start dates; and
combining the distribution over time of known member start dates with the member start-date probability distributions to generate the report.

18. The machine-readable storage medium as recited in claim 16, wherein selecting the cohort group further comprises:
for each cohort group, determining members of the cohort group as members of the social network having known member start dates and the cohort feature value;
determining a number of members in each cohort group; and
selecting the cohort group that has a most specific cohort feature from the cohort groups having the number of members above a predetermined threshold.

19. The machine-readable storage medium as recited in claim 16, wherein the cohort groups comprise:
a first cohort group having a cohort feature as a company identifier;
a second cohort group having a cohort feature as a company identifier and a function within the company; and
a third cohort group having a cohort feature as a company identifier and a title of the member.

20. The machine-readable storage medium as recited in claim 16, wherein identifying the time interval further comprises:
identifying the time interval based on one or more of a graduation date, dates of employment at other companies, and date the member posted employment at the company in the social network.
